(19) United States
(12) Patent Application Publication
(10) Pub. No.: US 2025/0287283 A1
(43) Pub. Date: Sep. 11, 2025

(54) Managing Conditional Reconfiguration After User Equipment (UE) Execution of Mobility Procedure

(71) Applicant: Telefonaktiebolaget LM Ericsson (publ), Stockholm (SE)

(72) Inventors: Jens Bergqvist, Linköping (SE); Pontus Wallentin, Linköping (SE); Cecilia Eklöf, Täby (SE); Icaro Leonardo Da Silva, Solna (SE); Alessio Terzani, Stockholm (SE)

(21) Appl. No.: 18/858,830

(22) PCT Filed: Jun. 13, 2023
(86) PCT No.: PCT/SE2023/050589

§ 371 Date: Oct. 22, 2024

Related U.S. Application Data
(60) Provisional application No. 63/354,391, filed on Jun. 22, 2022.

(51) Int. Cl. H04W 36/36; H04W 36/00; H04W 36/08

(52) U.S. Cl. CPC H04W 36/362; H04W 36/0061; H04W 36/08

(57) ABSTRACT

Embodiments include methods for a user equipment (UE) configured to communicate with a radio access network (RAN) via at least a master cell group (MCG). Such methods include receiving a plurality of conditional reconfigurations from the RAN. Each conditional reconfiguration is associated with a mobility procedure. one or more candidate target cells. and an execution condition. Such methods include storing the plurality of conditional reconfigurations and executing. according to a first reconfiguration. a first mobility procedure towards a first target cell served by a second RAN node. The first mobility procedure and the conditional reconfigurations are associated with a same one of the MCG and a secondary cell group (SCG) for the UE. Such methods include selectively maintaining or releasing each of the stored conditional reconfigurations. after executing the first mobility procedure. Other embodiments include complementary methods for the second RAN node and for a first RAN node.

### TECHNICAL FIELD

The present disclosure relates generally to wireless networks and more specifically to techniques that improve handling of conditional reconfigurations stored by a user equipment (UE), particularly after the UE performs a mobility procedure towards a target cell in a wireless network.

### BACKGROUND

Long-Term Evolution (LTE) is an umbrella term that refers to radio access technologies developed within the Third-Generation Partnership Project (3GPP) and initially standardized in Release 8 (Rel-8) and Release 9 (Rel-9), also known as Evolved UTRAN (E-UTRAN). LTE is targeted at various licensed frequency bands and is accompanied by improvements to non-radio aspects commonly referred to as System Architecture Evolution (SAE), which includes Evolved Packet Core (EPC) network. LTE continues to evolve through subsequent releases.

LTE Rel-10 supports bandwidths larger than 20 MHz. To remain compatible with legacy UEs from earlier releases (e.g., LTE Rel-8), a wideband LTE Rel-10 carrier (e.g., >20 MHz) should appear as a plurality of carriers (“component carriers” or CCs), each preferably having the same structure as an LTE Rel-8 carrier. The Rel-10 UE can received the multiple CCs based on Carrier Aggregation (CA). The CCs can also be considered “cells”, such that a UE in CA has one primary cell (PCell) and one or more secondary cells (SCells).

LTE Rel-12 introduced dual connectivity (DC) whereby a UE can be connected to two network nodes simultaneously, thereby improving connection robustness and/or capacity. In LTE DC, these two network nodes are referred to as master eNB (MeNB) and secondary eNB (SeNB), or more generally as master node (MN) and secondary node (SN). In particular, a UE is configured with a Master Cell Group (MCG) associated with the MN and a Secondary Cell Group (SCG) associated with the SN. Each cell group includes a PCell and may include one or more SCells.

Currently the fifth generation (5G) of cellular systems is being standardized within 3GPP. 5G is developed for maximum flexibility to support a variety of different use cases. These include enhanced mobile broadband (eMBB), machine type communications (MTC), ultra-reliable low latency communications (URLLC), side-link device-to-device (D2D), and several other use cases. 5G/NR technology shares many similarities with 4G/LTE. For example, both PHYs utilize similar arrangements of time-domain physical resources into 1-ms subframes that include multiple slots of equal duration, with each slot including multiple OFDM-based symbols.

Several DC (or more generally, multi-connectivity) scenarios are considered for NR. These include NR-DC that is similar to LTE-DC mentioned above, except that both the MN and SN (referred to as “gNBs”) employ the NR interface to communicate with the UE. In addition, NR supports various multi-RAT DC (MR-DC) scenarios in which a UE can be configured to utilize resources from one node providing E-UTRA/LTE access and another node providing NR access. One node acts as the MN (e.g., providing MCG) and the other as the SN (e.g., providing SCG), with the MN and SN being connected via a network interface and at least the MN being connected to a core network (e.g., EPC or 5GC).

A common mobility procedure for UEs connected to NR or LTE networks (e.g., in RRC_CONNECTED state, explained in more detail below) is handover (HO) between cells. A UE is handed over from a source or serving cell, provided by a source node, to a target cell provided by a target node. In general, for LTE (or NR), handover source and target nodes are different eNBs (or gNBs), although intra-node handover between different cells provided by a single eNB (or gNB) is possible. Successful handovers ensure that the UE moves around in the coverage area of different cells without causing too many interruptions in the data transmission.

Even so, handover and other mobility procedures can have various problems related to robustness. For example, a HO command is normally sent when the radio conditions for the UE are already quite bad, such as at or near cell borders. As such, the HO command may need to be segmented (e.g., to allow for redundancy to protect against errors) and/or retransmitted one or more times before it reaches the UE. In such case, the HO command may not reach the UE in time (or at all) before the degraded connection with the source node (e.g., the node hosting the UE's current serving cell) is dropped. Failure of handover to a target cell may lead to the UE declaring radio link failure (RLF) in the source cell. After the UE reestablishes a connection in another target cell, the UE can provide an RLF report to the network, indicating the cause(s) of the RLF in the source cell.

Some “conditional mobility” procedures have been introduced to address various difficulties with handovers and other mobility procedures. A main principle is that transmission and execution of a mobility (e.g., handover) command are separated. This allows the mobility command to be sent earlier to UE when the radio conditions are still good, thus increasing the likelihood that the message is successfully transferred. The execution of the mobility command is done at later point in time based on an associated execution condition.

More specifically, conditional handover (CHO) and SN-initiated intra-SN conditional PSCell change (CPC) procedures based on these principles were specified in 3GPP Rel-16. It is expected that 3GPP Rel-17 will include support for other conditional mobility procedures such as conditional PSCell addition (CPA), inter-SN CPC (SN or MN initiated), and MN-initiated intra-SN CPC.

Conditional mobility procedures such as CHO, CPC, CPA, etc. are facilitated by a conditional reconfiguration framework in which the network provides a UE with one or more reconfigurations, each with associated execution condition(s). Each reconfiguration can be provided in an RROReconfiguration message (in NR) or an RRCConnectionReconfiguration message (in LTE). When the UE later detects the execution condition(s) associated with one of the earlier-received reconfigurations, the UE executes the associated reconfiguration to perform the relevant mobility procedure (e.g., HO, PSCell change, PSCell addition, etc.).

In general, a UE receives conditional reconfigurations from a first RAN node (e.g., eNB, gNB, etc.) serving a first cell in which the UE is connected. The conditional reconfigurations are associated with respective candidate target cells, which may be served by the first RAN node or by other RAN nodes. From a mobility perspective, the first RAN node providing the conditional reconfigurations is considered a source RAN node (with the first cell being a source cell) and the RAN nodes serving the respective candidate target cells are considered candidate target RAN nodes.

### SUMMARY

In some cases, however, the UE may perform a mobility procedure (e.g., HO) to move from the first cell to a second cell before executing any of the conditional reconfigurations provided by the first RAN node. However, it is currently unclear whether the UE should release (e.g., discard) the conditional reconfigurations or continue to evaluate them when operating in the second cell.

In some cases, the first RAN node may provide each conditional reconfiguration in a format that is relative or differential to the configuration of the source cell (e.g., first cell) in which the UE operates. These are often referred to “delta configurations” and include only parameters of the source cell that need to be modified for the corresponding target cell. However, the second cell may be configured with different parameters than the first cell, so it is unclear how the UE should handle the delta configurations that are relative to the first cell after moving to the second cell.

An object of embodiments of the present disclosure is to improve conditional mobility operations of UEs in a RAN, such as by facilitating solutions to exemplary problems, issues, and/or difficulties summarized above and described in more detail below.

Some embodiments of the present disclosure include methods (e.g., procedures) for a UE configured to communicate with a RAN via at least an MCG.

These exemplary methods include receiving a plurality of conditional reconfigurations from the RAN. Each conditional reconfiguration is associated with a mobility procedure, one or more candidate target cells, and an execution condition. These exemplary methods include storing the plurality of conditional reconfigurations. These exemplary methods include executing, according to a first reconfiguration, a first mobility procedure towards a first target cell served by a second RAN node. The first mobility procedure and the plurality of stored conditional reconfigurations are associated with a same one of the MCG and an SCG for the UE. These exemplary methods include selectively maintaining or releasing each of the stored conditional reconfigurations, after executing the mobility procedure.

In some embodiments, selectively maintaining or releasing each of the stored conditional reconfigurations is based on one or more of the following:
an indication received from the RAN in relation to the first mobility procedure;
content of the stored conditional reconfiguration;
content of one or more other of the stored conditional reconfigurations;
type of mobility procedure associated with the stored conditional reconfiguration;
identity of the first target cell;
content of the first reconfiguration; and
type of the executed first mobility procedure.

Other embodiments include methods (e.g., procedures) for a first RAN node configured to provide an MCG for a UE. These exemplary methods are generally complementary to the exemplary methods for UEs that were summarized above.

These exemplary methods include sending the following to the UE:
a plurality of conditional reconfigurations, where each conditional reconfiguration is associated with a mobility procedure, one or more candidate target cells, and an execution condition; and.
one or more indications of whether the UE should maintain or release the plurality of conditional reconfigurations after execution of a first mobility procedure towards a first target cell served by a second RAN node
   The first mobility procedure and the plurality of conditional reconfigurations are associated with a same one of the MCG and an SCG for the UE. The exemplary method also includes subsequently performing and/or facilitating, according to a first reconfiguration, the first mobility procedure for the UE towards the first target cell served by the second RAN node.

Other embodiments include methods (e.g., procedures) for a first RAN node configured to provide an MCG for a UE. These exemplary methods are generally complementary to the exemplary methods for UEs for first RAN nodes that were summarized above.

These exemplary methods include sending, to the UE or to a first RAN node configured to provide an MCG for the UE, one or more indications of whether the UE should maintain or release a plurality of conditional reconfigurations after execution of a first mobility procedure towards a first target cell served by the second RAN node. Each conditional reconfiguration is associated with a mobility procedure, one or more candidate target cells, and an execution condition. Also, the first mobility procedure and the plurality of conditional reconfigurations are associated with a same one of the MCG and an SCG for the UE. These exemplary methods include performing and/or facilitating, according to a first reconfiguration, the first mobility procedure for the UE towards the first target cell served by the second RAN node.

The following summary of embodiments applies to the methods for the UE, the first RAN node, and the second RAN node, summarized above.

In some embodiments, the first mobility procedure towards the first target cell is a handover or a conditional handover (CHO). Each conditional reconfiguration is associated with a conditional handover (CHO), where the candidate target cell is a primary cell (PCell) of an MCG.

In other embodiments, the first mobility procedure towards the first target cell is one of the following: non-conditional primary SCG cell (PSCell) change, non-conditional PSCell addition, SCG addition, SCG modification, and SCG release. Also, each conditional reconfiguration is associated with one of the following mobility procedures:
conditional primary SCG cell (PSCell) addition (CPA), wherein the candidate target cell is a PSCell of an SCG; and
conditional PSCell change (CPC), wherein the candidate target cell is a PSCell of an SCG.

In other embodiments, the first mobility procedure towards the first target cell is a CPA or a CPC, and each conditional reconfiguration is associated with one of the following mobility procedures:
CPA, wherein the candidate target cell is a PSCell of an SCG; or
CPC, wherein the candidate target cell is a PSCell of an SCG.

In some embodiments, each conditional reconfiguration includes identifiers of one or more of the following:
other conditional reconfigurations that should be maintained by the UE after execution of the associated mobility procedure; and
other candidate target cells whose associated conditional reconfigurations should be maintained by the UE after execution of the associated mobility procedure.

In some embodiments, each conditional reconfiguration includes at least one field associated with a version or release of functionality. The version or release further indicates whether the UE should maintain or release the conditional reconfiguration after execution of a mobility procedure.

In some embodiments, each conditional reconfiguration includes a first indication of whether a state of the associated candidate target cell is activated or deactivated after execution of the associated mobility procedure. Moreover, each first indication further indicates whether the UE should maintain or release the associated conditional reconfiguration after execution of the associated mobility procedure.

In some embodiments, the one or more indications of whether the UE should maintain or release a plurality of conditional reconfigurations include a single indication that applies to the plurality (i.e., all) of conditional reconfigurations.

Other embodiments include UEs (e.g., wireless devices, IoT devices, etc. or component(s) thereof) and RAN nodes (e.g., base stations, eNBs, gNBs, ng-eNBs, en-gNBs, etc., or components thereof) configured to perform operations corresponding to any of the exemplary methods described herein. Other embodiments include non-transitory, computer-readable media storing program instructions that, when executed by processing circuitry, configure such UEs or RAN nodes to perform operations corresponding to any of the exemplary methods described herein.

These and other embodiments disclosed herein can provide various technical advantages and/or benefits. For example, embodiments can inform a UE about what stored conditional reconfigurations that it should maintain (e.g., to facilitate a subsequent mobility procedure with low delay or latency) after a cell group change or other mobility procedure in a network. In this manner, both UE and network are aware of conditional reconfigurations that the UE is evaluating at any given moment, which prevents configuration mismatches between UE and network. This also prevents unnecessary reconfiguration failures due to the network assuming the UE is operating with a different configuration than it actually is. At a high level, embodiments can improve mobility robustness for both UEs and networks.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows a high-level view of an exemplary LTE network architecture.

FIG. 2 is a block diagram of an exemplary LTE control plane (CP) protocol stack.

FIG. 3 shows a high-level view of an exemplary 5G/NR network architecture.

FIG. 4 shows a high-level view of dual connectivity (DC) in combination with carrier aggregation (CA).

FIGS. 5-6 show high-level views of exemplary network architectures that support multi-RAT DC (MR-DC) using EPC and 5GC, respectively.

FIG. 7 is a block diagram showing a high-level comparison of CP architectures of two DC alternatives, EN-DC with EPC and MR-DC with 5GC, respectively.

FIG. 8 shows signaling for an exemplary conditional handover (CHO) procedure.

FIG. 9 shows signaling for an exemplary SN-initiated, intra-SN conditional PSCell change procedure (CPC).

FIGS. 10A-C show an exemplary ASN.1 data structure for a Conditional-Reconfiguration information element (IE) and various fields included therein.

FIGS. 11-13 show ASN.1 data structures for various IEs or messages, according to various embodiments of the present disclosure.

FIG. 14 is a flow diagram of another exemplary method (e.g., procedure) for a UE, according to various embodiments of the present disclosure.

FIG. 15 is a flow diagram of an exemplary method (e.g., procedure) for a first RAN node, according to various embodiments of the present disclosure.

FIG. 16 is a flow diagram of an exemplary method (e.g., procedure) for a second RAN node, according to various embodiments of the present disclosure.

FIG. 17 shows a communication system according to various embodiments of the present disclosure.

FIG. 18 shows a UE according to various embodiments of the present disclosure.

FIG. 19 shows a network node according to various embodiments of the present disclosure.

FIG. 20 shows host computing system according to various embodiments of the present disclosure.

FIG. 21 is a block diagram of a virtualization environment in which functions implemented by some embodiments of the present disclosure may be virtualized.

FIG. 22 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In general, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is generally used. However, the concepts disclosed herein are not limited to a 3GPP system, and can be applied in any system that can benefit from the concepts, principles, and/or embodiments described herein.

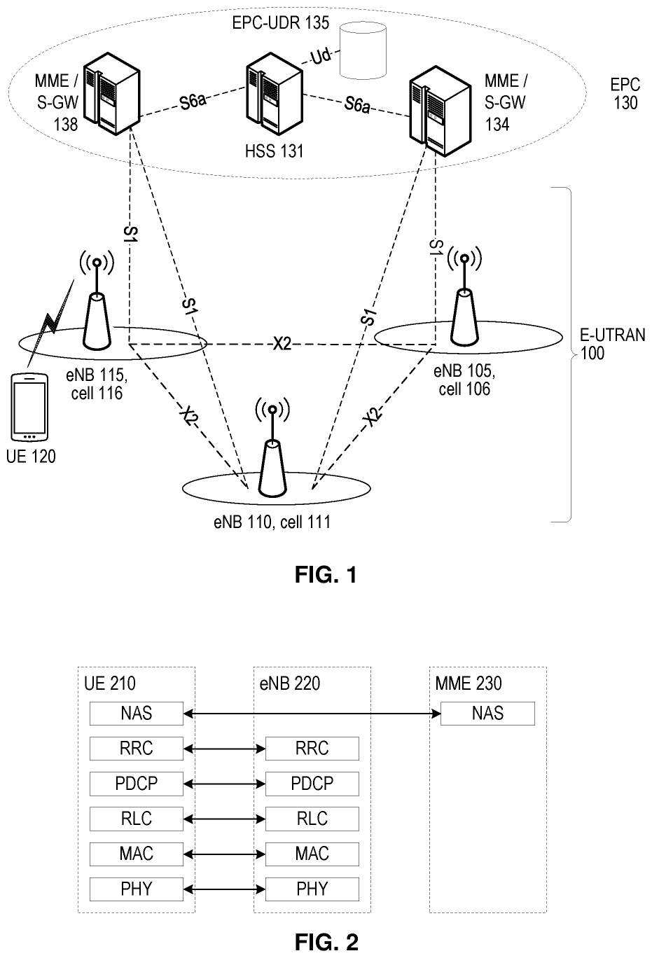

An overall exemplary architecture of a network comprising LTE and SAE is shown in FIG. 1. E-UTRAN 100 includes one or more evolved Node B's (eNB), such as eNBs 105, 110, and 115, and one or more user equipment (UE), such as UE 120. E-UTRAN 100 is responsible for all radio-related functions in the network, including radio bearer control, radio admission control, radio mobility control, scheduling, and dynamic allocation of resources to UEs in uplink and downlink, as well as security of the communications with the UE. These functions reside in the eNBs, such as eNBs 105, 110, and 115. Each of the eNBs can serve a geographic coverage area including one or more cells, including cells 106, 111, and 115 served by eNBs 105, 110, and 115, respectively.

The eNBs in the E-UTRAN communicate with each other via the X2 interface, as shown in FIG. 1. The eNBs also are responsible for the E-UTRAN interface to the EPC 130, specifically the SI interface to the Mobility Management Entity (MME) and the Serving Gateway (SGW), shown collectively as MME/S-GWs 134 and 138 in FIG. 1. In general, the MME/S-GW handles both the overall control of the UE and data flow between the UE and the rest of the EPC. More specifically, the MME processes the signaling (e.g., control plane) protocols between the UE and the EPC, which are known as the Non-Access Stratum (NAS) protocols. The S-GW handles all Internet Protocol (IP) data packets (e.g., data or user plane) between the UE and the EPC and serves as the local mobility anchor for the data bearers when the UE moves between eNBs, such as eNBs 105, 110, and 115.

EPC 130 can also include a Home Subscriber Server (HSS) 131, which manages user- and subscriber-related information. HSS 131 can also provide support functions in mobility management, call and session setup, user authentication and access authorization. The functions of HSS 131 can be related to the functions of legacy Home Location Register (HLR) and Authentication Centre (AuC) functions or operations. HSS 131 can also communicate with MMEs 134 and 138 via respective S6a interfaces.

In some embodiments, HSS 131 can communicate with a user data repository (UDR)-labelled EPC-UDR 135 in FIG. 1—via a Ud interface. EPC-UDR 135 can store user credentials after they have been encrypted by AuC algorithms. These algorithms are not standardized (i.e., vendor-specific), such that encrypted credentials stored in EPC-UDR 135 are inaccessible by any other vendor than the vendor of HSS 131.

FIG. 2 illustrates a block diagram of an exemplary control plane (CP) protocol stack between a UE, an eNB, and an MME. The exemplary protocol stack includes Physical (PHY), Medium Access Control (MAC), Radio Link Control (RLC), Packet Data Convergence Protocol (PDCP), and Radio Resource Control (RRC) layers between the UE and eNB. The PHY layer is concerned with how and what characteristics are used to transfer data over transport channels on the LTE radio interface. The MAC layer provides data transfer services on logical channels, maps logical channels to PHY transport channels, and reallocates PHY resources to support these services. The RLC layer provides error detection and/or correction, concatenation, segmentation, and reassembly, reordering of data transferred to or from the upper layers. The PDCP layer provides ciphering/deciphering and integrity protection for both CP and user plane (UP), as well as other UP functions such as header compression. The exemplary protocol stack also includes non-access stratum (NAS) signaling between the UE and the MME.

The RRC layer controls communications between a UE and an eNB at the radio interface, as well as the mobility of a UE between cells in the E-UTRAN. After a UE is powered ON it will be in the RRC IDLE state until an RRC connection is established with the network, at which time the UE will transition to RRC_CONNECTED state (e.g., where data transfer can occur). The UE returns to RRC IDLE after the connection with the network is released. In RRC_ IDLE state, the UE does not belong to any cell, no RRC context has been established for the UE (e.g., in E-UTRAN), and the UE is out of UL synchronization with the network. Even so, a UE in RRC IDLE state is known in the EPC and has an assigned IP address.

Furthermore, in RRC IDLE state, the UE's radio is active on a discontinuous reception (DRX) schedule configured by upper layers. During DRX active periods (also referred to as “DRX On durations”), an RRC_IDLE UE receives system information (SI) broadcast by a serving cell, performs measurements of neighbor cells to support cell reselection, and monitors a paging channel for pages from the EPC via an eNB serving the cell in which the UE is camping.

A UE must perform a random-access (RA) procedure to move from RRC_IDLE to RRC CONNECTED state. In RRC_CONNECTED state, the cell serving the UE is known and an RRC context is established for the UE in the serving eNB, such that the UE and eNB can communicate. For example, a Cell Radio Network Temporary Identifier (C-RNTI)—a UE identity used for signaling between UE and network-is configured for a UE in RRC_CONNECTED state.

As briefly mentioned above, LTE Rel-12 introduced dual connectivity (DC) whereby a UE can be configured with a Master Cell Group (MCG) provided by a master node (MN) and a Secondary Cell Group (SCG) provided by a secondary node (SN). Each of the CGs is a group of serving cells that includes one MAC entity, a set of logical channels with associated RLC entities, a primary cell (PCell), and optionally one or more secondary cells (SCells). The term “special cell” (“SpCell” for short) refers to the MCG PCell or the primary SCG cell (PSCell) depending on whether the UE's MAC entity is associated with the MCG or the SCG, respectively. In non-DC operation (e.g., CA), SpCell refers to the PCell. An SpCell is always activated and supports physical uplink control channel (PUCCH) transmission and contention-based random access by UEs.

The MN provides system information (SI) and terminates the control plane connection towards the UE and, as such, is the controlling node of the UE, including handovers to and from SNs. The SN provides additional radio resources (e.g., bearers) for certain bearers that have resources from both MCG and SCG. The reconfiguration, addition, and removal of SCells can be performed by RRC. When adding a new SCell, dedicated RRC signaling is used to send the UE all required SI of the SCell, such that UEs need not acquire SI directly from the SCell broadcast. MCG and/or SCG can include multiple cells working in CA.

Both MN and SN can terminate the user plane (UP) to the UE, which includes three different types of bearers. MCG bearers are terminated in the MN, and the S1-U connection for the corresponding bearer(s) to the S-GW is terminated in the MN. The SN is not involved in the transport of UP data for MCG bearers. Likewise, SCG bearers are terminated in the SN, which can be directly connected with the S-GW via S1-U. The MN is not involved in the transport of UP data for SCG bearers. Split bearers (and their corresponding S1-U connections to S-GW) are also MN-terminated with PDCP data transferred between MN and SN via X2-U.

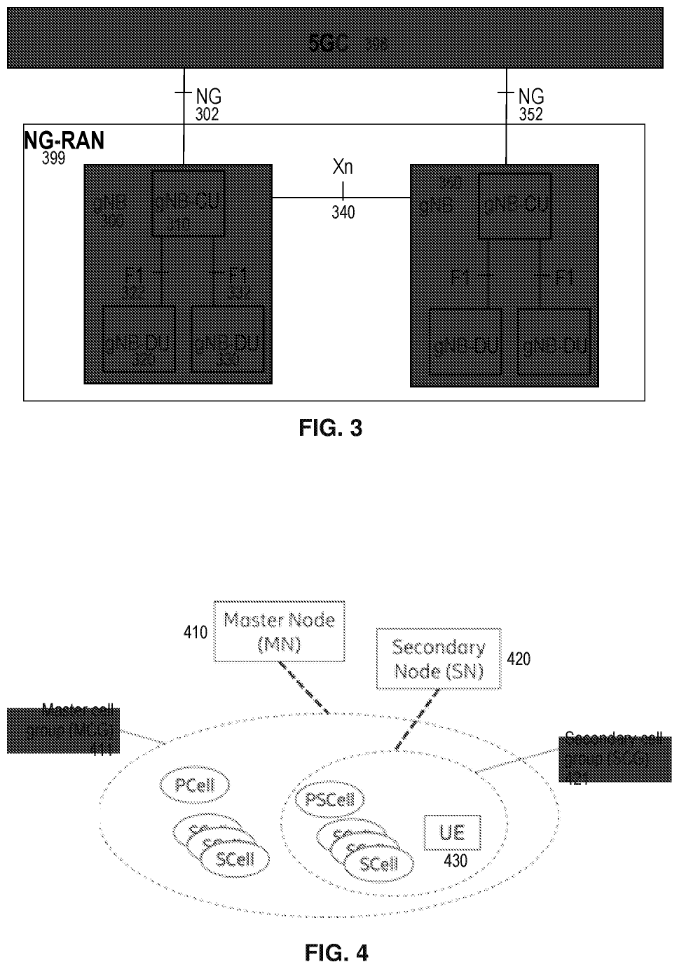

FIG. 3 illustrates a high-level view of the 5G network architecture, consisting of a Next Generation RAN (NG-RAN) 399 and a 5G Core (5GC) 398. NG-RAN 399 can include a set of gNodeB's (gNBs) connected to the 3GC via one or more NG interfaces, such as gNBs 300, 350 connected via interfaces 302, 352, respectively. In addition, the gNBs can be connected to each other via one or more Xn interfaces, such as Xn interface 340 between gNBs 300 and 350. With respect to the NR interface to UEs, each of the gNBs can support frequency division duplexing (FDD), time division duplexing (TDD), or a combination thereof.

NG-RAN 399 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 3 include a central (or centralized) unit (CU or gNB-CU) and one or more distributed (or decentralized) units (DU or gNB-DU). For example, gNB 300 includes gNB-CU 310 and gNB-DUs 320 and 330. CUs (e.g., gNB-CU 310) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUS and DUs can include various circuitry needed to perform their respective functions, including processing circuitry, transceiver circuitry (e.g., for communication), and power supply circuitry.

A gNB-CU connects to gNB-DUs over respective F1 logical interfaces, such as interfaces 322 and 332 shown in FIG. 3. The gNB-CU and connected gNB-DUs are only visible to other gNBs and the 5GC as a gNB. In other words, the F1 interface is not visible beyond gNB-CU. In the gNB split CU-DU architecture illustrated by FIG. 3, DC can be achieved by allowing a UE to connect to multiple DUs served by the same CU or by allowing a UE to connect to multiple DUs served by different CUs.

As briefly mentioned above, 5G/NR technology shares many similarities with 4G/LTE. For example, both PHYs utilize similar arrangements of time-domain physical resources into 1-ms subframes that include multiple slots of equal duration, with each slot including multiple OFDM-based symbols. As another example, the NR RRC layer includes RRC_IDLE and RRC CONNECTED states like LTE, but adds another state known as RRC_INACTIVE.

In addition to providing coverage via “cells,” as in LTE, NR networks also provide coverage via “beams.” In general, a downlink (DL) “beam” is a coverage area of a network-transmitted RS that may be measured or monitored by a UE. For example, these RS can include any of the following, alone or in combination: SS/PBCH block (SSB), CSI-RS, tertiary reference signals (or any other sync signal), positioning RS (PRS), DMRS, phase-tracking reference signals (PTRS), etc. In general, SSB is available to all UEs regardless of RRC state, while other RS (e.g., CSI-RS, DM-RS, PTRS) are associated with specific UEs that have a network connection, i.e., in RRC_CONNECTED state.

DC is also an important feature for 5G/NR networks. 3GPP TR 38.804 (v14.0.0) describes various exemplary DC scenarios or configurations in which the MN and SN can apply either NR RAT, LTE RAT, or both, and can connect to either EPC or 5GC. The following terminology is used to describe these exemplary DC scenarios or configurations:
DC: LTE DC (i.e., both MN and SN employ LTE, as discussed above);
EN-DC: LTE-NR DC where MN (eNB) employs LTE and SN (gNB) employs NR, and both are connected to EPC.
NGEN-DC: LTE-NR dual connectivity where a UE is connected to one ng-eNB that acts as a MN and one gNB that acts as a SN. The ng-eNB is connected to the 5GC and the gNB is connected to the ng-eNB via the Xn interface.
NE-DC: LTE-NR dual connectivity where a UE is connected to one gNB that acts as a MN and one ng-eNB that acts as a SN. The gNB is connected to 5GC and the ng-eNB is connected to the gNB via the Xn interface.
NR-DC (or NR-NR DC): both MN and SN employ NR and connect to 5GC via NG.
MR-DC (multi-RAT DC): a generalization of the Intra-E-UTRA Dual Connectivity (DC) described in 3GPP TS 36.300 (v16.3.0), where a multiple Rx/Tx UE may be configured to utilize resources provided by two different nodes connected via non-ideal backhaul, one providing E-UTRA access and the other one providing NR access. One node acts as the MN and the other as the SN, with one using LTE and the other using NR. The MN and SN are connected via a network interface and at least the MN is connected to the core network. EN-DC, NE-DC, and NGEN-DC are different example cases of MR-DC.

FIG. 4 shows a high-level illustration of a UE (430) arranged in DC with CA. In this illustration, each of the MN (410) and the SN (420) can be either an eNB or a gNB, in accordance with the various DC scenarios mentioned above. The MN provides the UE's MCG (411) consisting of a PCell and three SCells arranged in CA, while the SN provides the UE's SCG (421) consisting of a PSCell and three SCells arranged in CA.

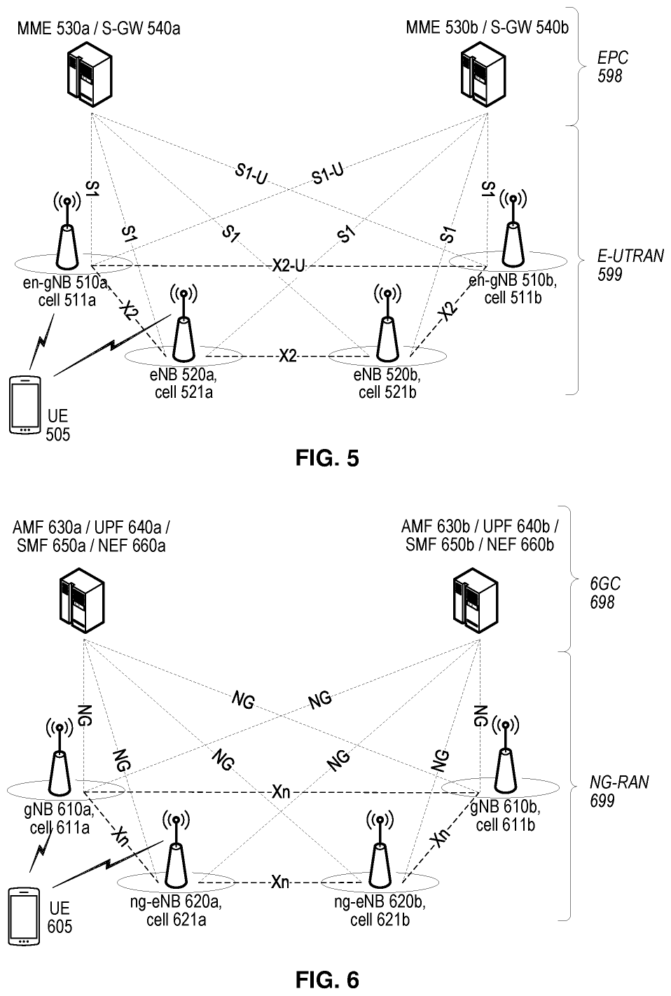

FIG. 5 shows a high-level view of an exemplary network architecture that supports EN-DC, including an E-UTRAN (599) and an EPC (598). The E-UTRAN can include en-gNBs (e.g., 510a,b) and eNBs (e.g., 520a,b) that are interconnected with each other via respective X2 (or X2-U) interfaces. The eNBs can be similar to those shown in FIG. 1, while the ng-eNBs can be similar to the gNBs shown in FIG. 3 except that they connect to EPC via an S1-U interface rather than to 5GC via an X2 interface. The eNBs also connect to EPC via an S1 interface, similar to the arrangement shown in FIG. 1. More specifically, en-gNBs (e.g., 510a,b) and eNBs 520 (e.g., 520a,b) connect to MMEs (e.g., 530a,b) and S-GWs (e.g., 540a,b) in EPC.

Each of the en-gNBs and eNBs can serve a geographic coverage area including one or more cells (e.g., 511a-b, 521a-b). Depending on the cell in which it is located, a UE can communicate with the en-gNB or eNB serving that cell via the NR or LTE radio interface, respectively. In addition, a UE can be in EN-DC connectivity with a first cell served by an eNB and a second cell served by an en-gNB, as exemplified by UE (505) in EN-DC with cells (510a, 520a) in FIG. 5.

In addition to providing coverage via “cells,” as in LTE, NR networks also provide coverage via “beams.” In general, a DL “beam” is a coverage area of a network-transmitted RS that may be measured or monitored by a UE. In NR, for example, such RS can include any of the following, alone or in combination: SS/PBCH block (SSB), CSI-RS, tertiary reference signals (or any other sync signal), positioning RS (PRS), DMRS, phase-tracking reference signals (PTRS), etc. In general, SSB is available to all UEs regardless of RRC state, while other RS (e.g., CSI-RS, DM-RS, PTRS) are associated with specific UEs that have a network connection, i.e., in RRC CONNECTED state.

FIG. 6 shows a high-level view of an exemplary network architecture that supports MR-DC configurations based on a 5GC. More specifically, FIG. 6 shows an NG-RAN (699) and a 5GC (698). The NG-RAN can include gNBs (e.g., 610a,b) and ng-eNBs (e.g., 620a,b) that are interconnected with each other via respective Xn interfaces. The gNBs and ng-eNBs are also connected via the NG interfaces to the 5GC, more specifically to the access and mobility management functions (AMFs, e.g., 630a,b) via respective NG-C interfaces and to the user plane functions (UPFs, e.g., 640a,b) via respective NG-U interfaces. Moreover, the AMFs can communicate with one or more session management functions (SMFs, e.g., 650a,b) and network exposure functions (NEFs, e.g., 660a,b).

Each of the gNBs can be similar to those shown in FIG. 5, while each of the ng-eNBs can be similar to the eNBs shown in FIG. 1 except that they connect to 5GC via an NG interface rather than to EPC via an SI interface. Each of the gNBs and ng-eNBs can serve a geographic coverage area including one or more cells (e.g., 611a-b, 621a-b). The gNBs and ng-eNBs can also use various directional beams to provide coverage in the respective cells. Depending on the cell in which it is located, a UE can communicate with the gNB or ng-eNB serving that cell via the NR or LTE radio interface, respectively. In addition, a UE can be in MR-DC with a first cell served by an ng-eNB and a second cell served by a gNB, as exemplified by UE (605) in MR-DC with cells (610a, 620a) in FIG. 6.

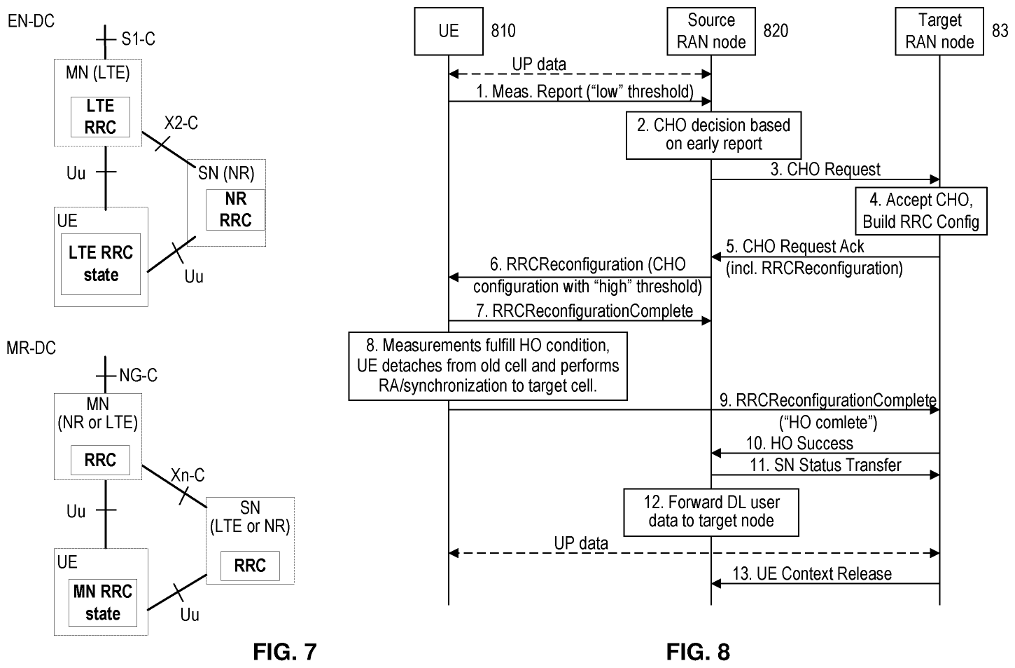

FIG. 7 is a block diagram showing a high-level comparison of control plane (CP) architectures in EN-DC with EPC (e.g., FIG. 5) and MR-DC with 5GC (e.g., FIG. 6). The particular RATs used by MN and SN in these two architectures are shown in parentheses and discussed in more detail above. In either case, the UE has a single RRC state based on the MN RRC (LTE or NR) and a single CP connection towards the CN via Uu interface to MN and S1-C or NG-C interface to CN, as the case may be. RRC PDUs generated by the SN can be transported via the X2-C or Xn-C interface to the MN (as the case may be) and the Uu interface from MN to

UE. The MN always sends the initial SN RRC configuration via MCG SRB (SRB1), but subsequent reconfigurations may be transported via MN or SN. When transporting RRC PDU from the SN, the MN does not modify the UE configuration provided by the SN.

As shown in FIG. 7, each of MN and SN has an RRC entity for creating RRC Information Elements (IE) and messages for configuring the UE. Since the SN is responsible for its own resources, it provides the UE with the SCG configuration in an RRC message and also the radio bearer configuration in an IE, for all bearers that are terminated in the SN. The MN in turn creates the MCG configuration and the radio bearer configuration for all bearers terminated in the MN. The cell group configuration includes the configuration of L1 (physical layer), MAC and RLC. The radio bearer configuration includes the configuration of PDCP (and SDAP in case of 5GC).

As briefly mentioned above, conditional handover (CHO) was introduced in 3GPP Rel-16to improve robustness of UE mobility. The key idea in CHO is separation of transmission and execution of the handover command. This allows the handover command to be sent to a UE earlier when the radio conditions are still good, thus increasing the likelihood that the message is successfully transferred. The execution of the handover command is done later in time based on an associated execution condition.

The execution condition is typically based on a threshold. For example, a signal strength of candidate target cell becomes X dB better than the serving cell (so called “A3 event”). A preceding measurement reporting event could use a threshold Y that is selected to be lower than X used as the handover execution condition. This allows the serving cell to prepare the handover upon reception of an early measurement report and to provide the RRCConnectionReconfiguration with mobilityControlInfo (for LTE), or a RRCReconfiguration with either a reconfigurationWithSync or a CellGroupConfig (for NR) at a time when the radio link between the source cell and the UE is still relatively stable.

As used herein, a cell for which conditional handover (or other conditional mobility procedure) is configured is called a “candidate target cell” or “potential target cell”. Similarly, a RAN node controlling a candidate/potential target cell is called “candidate target node” or “potential target node”. Once the conditional mobility execution condition has been fulfilled for a candidate/potential target cell and mobility execution towards this cell has been triggered, this cell is no longer “potential” or a “candidate” in the normal senses of the words, since it is now certain that the mobility operation will be executed towards it. Rather, the candidate/potential target cell can then be referred to as the “target cell”.

FIG. 8 illustrates an exemplary signal flow between a UE 810, a source RAN node 820, and a target RAN node 830 for a CHO. For example, the source and target nodes can be gNBs and/or components of gNBs, such as CUs and/or DUs.

This procedure involves two different measurement thresholds: a low threshold and a high threshold. The two thresholds can be expressed as different levels of a particular metric, e.g., signal strength, signal quality, etc. For example, the high threshold could be that the quality of the mobility reference signal (MRS) of the target cell or beam becomes X dB stronger than the MRS of the UE's serving cell (e.g., provided by the source RAN node), with the low threshold being less than the high threshold (i.e., target exceeds source by lower amount). As used in this context, MRS denotes a reference signal used for any mobility-related purpose. For example, in NR, MRS can be either SSB (SS/PBCH block) or CSI-RS. As a further example, for NR operating in unlicensed spectrum (referred to as NR-U), MRS can be a discovery reference signal (DRS) in addition to any of the signals mentioned above.

Initially, the UE may be transmitting and/or receiving user plane (UP) data with the source RAN node. The source RAN node can provide the UE a measurement configuration including the low threshold (not shown in the figure). Upon performing measurements that meet the low threshold, the UE can send a measurement report to the serving node (operation 1). While 30) performing the measurements and evaluating the low threshold, the UE continues operating in its current RRC configuration. In operation 2, based on this report, the source RAN node can decide to request an early handover of the UE to the target RAN node (e.g., to a cell indicated in the measurement report) and subsequently send this request (operation 3). For example, this early handover request can include a HandoverPreparationInformation IE such as described above.

The target RAN node performs admission control for the UE (operation 4) and responds with a CHO request acknowledgement (operation 5) that includes RRC configuration, similar to conventional handover. In operation 6, the source RAN node then sends the UE a RR (Reconfiguration message that includes a “CHO Configuration”, which can include the high threshold. After responding with an RRCReconfigurationComplete message (operation 7), the UE continues to perform measurements and whenever the high threshold condition is met for a target cell, it can detach from the source cell and, after performing a RA procedure and synchronizing with the target cell, send the target RAN node an RRCReconfigurationComplete message (e.g., operations 8-9). Even so, the UE can remain in the source cell for an extended amount of time in case the high threshold condition is not fulfilled.

In operation 10, the target RAN node sends a HANDOVER SUCCESS message to the source gNB indicating the UE has successfully established the target connection. Upon reception of the handover success indication, the source RAN node stops scheduling any further DL or UL data to the UE and sends an SN STATUS TRANSFER message to the target RAN node indicating the latest PDCP SN transmitter and receiver status (operation 11). The source RAN node now also starts to forward User Data to the target RAN node (operation 12). Upon receiving the handover complete message (operation 9), the target RAN node can start exchanging UP data with the UE. The target RAN node also requests the AMF to switch the DL data path from the UPF from the source RAN node to the target RAN node (not shown). Once the path switch is completed the target RAN node sends the UE CONTEXT RELEASE to the source RAN node (operation 13).

When a UE successfully connects (e.g., completes RA) to a target cell during a CHO or a conventional handover, it releases all the conditional reconfigurations that it has stored. The RAN node serving the target cell may then provide the UE with new conditional reconfigurations if desired.

The conditional handover concept shown above can be generalized into a generic conditional reconfiguration framework, wherein a UE may be configured in advance with other types of reconfigurations that can be executed by an RRCReconfiguration message (in NR) or an RRCConnectionReconfiguration message (in LTE) when associated execution condition(s) is (are) triggered. Each such message is prepared by a candidate target RAN node, associated with a candidate target cell, and includes execution conditions that can be represented by one or more identifiers of measurement configuration(s). This conditional reconfiguration framework can be applied to the following mobility operations:
CHO (e.g., target candidate RR ('Reconfiguration message contains a reconfiguration with sync for the MCG);
Conditional PSCell Addition (CPA e.g., target candidate RRCReconfiguration message contains an SCG configuration which contains a reconfiguration with sync for a cell to be the PSCell of the SCG);
Conditional PSCell Change (CPC, e.g., target candidate RRCReconfiguration message includes an SCG configuration that contains a reconfiguration with sync for a new target candidate cell to be the PSCell of the SCG);
Conditional PSCell Release (e.g., source RRCReconfiguration message to be conditionally applied contains an SCG release indication); or
Conditional PSCell Suspend (e.g., source RRCReconfiguration message to be conditionally applied contains an SCG suspend indication).

An SN-initiated intra-SN CPC procedure was specified in 3GPP Rel-16. In this procedure, a UE operating in MR-DC receives a conditional reconfiguration that includes an RRCReconfiguration message containing an SCG configuration (e.g., a secondaryCellGroup field of a CellGroupConfig information element) with an associated execution condition (e.g., an A3/A5 event configuration). When the UE detects that the execution condition is fulfilled (i.e., it finds a neighbor cell that is better than the current PSCell by a configured amount), the UE perform PSCell change. The intra-SN solution for Rel-16 is only for scenarios where the (candidate) target PSCells are provided by the UE's current SN. Similar to CHO, when a UE successfully connects (e.g., completes RA) to a target cell during intra-SN CPC, it releases all the conditional reconfigurations that it has stored.

In 3GPP Rel-17 solutions for Conditional PSCell Addition (CPA) and inter-SN CPC are being discussed and introduced. The CPA procedure is used to add a PSCell/SCG to a UE currently configured with only an MCG, when associated execution conditions are fulfilled. CPA is initiated after the MN receives an SCG configuration from a candidate target SN (T-SN), which the MN then provides to the UE as part of a conditional reconfiguration together with the associated execution condition(s).

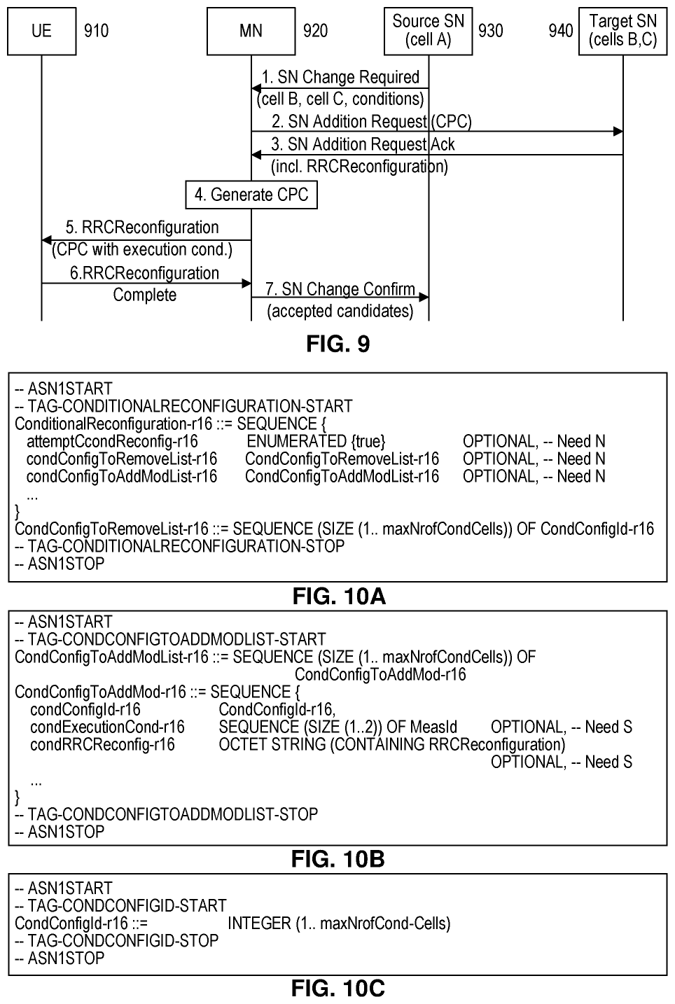

An inter-SN CPC procedure can be initiated by the MN or by the source SN (S-SN), with the MN handling the signaling toward the T-SN and the UE. FIG. 9 shows an exemplary SN-initiated, inter-SN CPC procedure between a UE 910, a MN 920, a source SN 930, and a target SN 940. In this example, the source SN provides the UE's current SCG including cell A, which is the UE's current PSCell. Likewise, the target SN provides cells B and C. Although not labeled as such in the figure, the target SN is considered a “candidate target SN” before the UE executes a mobility procedure towards the target SN. Each of the source SN, the target SN, and the MN can be an eNB, a gNB, or a CU of an eNB, a CU of a gNB, or any other type of RAN node.

In operation 1, the source SN sends to the MN an indication that a SN change is required for the UE, with cells B and C indicated as candidate PSCells for the UE, as well as conditions for the change. In operation 2, the MN sends an SN addition request to the target SN, indicating CPC towards candidate target PSCells B and C.

In operation 3, the target SN sends an SN Addition Request Ack that includes RRCReconfiguration messages corresponding to the target PSCells. In operation 4, the MN generates the CPC based on the information received in operations 1 and 3, and sends the RRCReconfiguration with conditions to the UE in operation 5. The UE acknowledges in operation 6, after which the MN sends the source SN an SN Change Confirm message indicating that the target PSCell candidates proposed in operation 1 were accepted by the UE for CPC.

Although not shown in FIG. 9, the UE can evaluate the condition(s) associated with the candidate target PSCells B and C, and when detected, perform a PSCell change to the candidate associated with the detected condition(s). At this point, the (candidate) target SN becomes the UE's SN and the candidate target PSCell becomes the UE's PSCell. Although not specified, it can be expected that when a UE successfully connects to a candidate target cell during CPA or inter-SN CPC, it should release all the conditional reconfigurations that it has stored, in a similar manner as CHO and intra-SN CPC.

One of the objectives of 3GPP Rel-18 work for mobility enhancements is “to specify mechanism and procedures of NR-DC with selective activation of the cell groups (at least for SCG) via L3 enhancements”, which includes “to allow subsequent cell group change after changing CG, without reconfiguration and re-initiation of CPC/CPA”. If this objective is met, it would reduce interruption time and signaling overhead for SCG changes, especially in the case of frequent SCG changes when operating in FR2 in NR. Conventionally, as mentioned above, configurations for other cell groups are released when the UE successfully connects (e.g., completes RA) towards a target PSCell, such that a subsequent SCG change requires providing the UE with updated configurations towards candidate target cells.

During preparation for a UE mobility procedure, the source RAN node sends the current UE configuration to the target RAN node, which prepares a UE configuration for the (candidate) target cell based on the current configuration and the capability of the UE and the target RAN node. The target RAN node packages this configuration as an RRCReconfiguration message, which it sends to the UE via the source RAN node.

In some cases, the target RAN node may provide the configuration in a format that is relative or differential to the configuration of the source cell in which the UE currently operates. These are often referred to “delta configurations” and include only parameters of UE's configuration in the source cell that need to be modified for the corresponding target cell.

However, if the target RAN node does not recognize something (e.g., an unsupported feature) in the UE's current configuration, the target RAN node will build and send a “full configuration” (or “fullConfig”). Upon receiving it, the UE will clear the current configuration and make a new configuration from scratch. A full configuration impacts the UE's MCG configuration and (if present) the UE's SCG configuration. The target RAN node may also build and send a full configuration when building a delta configuration is too complex. Further details about full configurations can be found in 3GPP TS 38.331 (v17.0.0) section 5.3.5.11.

When configuring a UE in MR-DC for PSCell change, the entire SCG configuration can be replaced by a new one based on including mrdc-ReleaseAndAdd field in the mrdc-SecondaryCellGroupConfig IE of the RRCReconfiguration message. In such case, the UE will first release the MR-DC configuration (including existing SCG) and then apply the new SCG configuration. In such case, the new SCG configuration is a full configuration and not based on the existing SCG configuration, which is released before applying the new one. This is further described by the following procedural text from 3GPP TS 38.331 (V17.0.0) section 5.3.5.3:

***Begin text from 3GPP TS 38.331***
1> if the RR (Reconfiguration includes the mrdc-SecondaryCellGroupConfig:
   2> if the mrdc-SecondaryCellGroupConfig is set to setup:
      3> if the mrdc-SecondaryCellGroupConfig includes mrdc-Release AndAdd:
         4> perform MR-DC release as specified in clause 5.3.5.10;
      3> if the received mrdc-SecondaryCellGroup is set to nr-SCG:
         4> perform the RRC reconfiguration according to 5.3.5.3 for the RRCReconfiguration message included in nr-SCG;
      3> if the received mrdc-SecondaryCellGroup is set to eutra-SCG:
         4> perform the RRC connection reconfiguration as specified in TS 36.331 [10], clause 5.3.5.3 for the RRCConnectionReconfiguration message included in eutra-SCG;
            *** End text from 3GPP TS 38.331***

To summarize, a UE receives conditional reconfigurations from a first RAN node (e.g., eNB, gNB, etc.) serving a first cell in which the UE is connected. The conditional reconfigurations are associated with respective candidate target cells, which may be served by the first RAN node or by other RAN nodes. From a mobility perspective, the first RAN node providing the conditional reconfigurations is considered a source RAN node (with the first cell being a source cell) and the RAN nodes serving the respective candidate target cells are considered candidate target RAN nodes.

In some cases, however, the UE may perform a mobility procedure (e.g., HO) to move from the first cell to a second cell before executing any of the conditional reconfigurations provided by the first RAN node. However, it is currently unclear whether the UE should release (e.g., discard) the conditional reconfigurations or continue to evaluate them when operating in the second cell.

In some cases, the first RAN node may provide each conditional reconfiguration as a delta configuration relative to the source cell (e.g., first cell) in which the UE operates, indicating only parameters of the source cell that need to be modified for the corresponding target cell. However, the second cell may be configured with different parameters than the first cell, so it is unclear how the UE should handle the delta configurations that are relative to the first cell after moving to the second cell.

For example, when a target candidate SN receives the SN Addition Request for CPC, it receives the UE's current SCG configuration and generates the SCG RRCReconfiguration for the candidate target PSCell as a delta configuration, based on that UE's current SCG configuration. That delta configuration contains only the parameters for the candidate target PSCell that need to be modified by the UE when the UE moves to that cell. For other omitted parameters, the UE should apply the parameters of the current SCG configuration. But if the UE has changed SCGs since receiving the RRCReconfiguration for the candidate target PSCell, the parameters assumed/applied by the UE may be incorrect.

Embodiments of the present disclosure address these and other problems, difficulties, or issues by providing techniques whereby a UE can determine whether to maintain or release a stored conditional reconfiguration associated with a candidate target cell after execution of a mobility procedure towards a target cell, such as after a successful RA procedure to a target SpCell at a handover, PSCell change, or PSCell addition. In various embodiments, the UE can determine to release or maintain each of its stored conditional reconfigurations based on one or more of the following:
content of the conditional reconfiguration, such as whether it includes an mrdc-Release AndAdd indication for an SCG or a delta configuration for the SCG;
an identity of the target cell for the executed mobility procedure;
type of the executed mobility procedure, e.g., whether it is a HO, PSCell change, or PSCell addition procedure, whether it was conditional based on UE measurements or caused directly by a network command, etc.;
type of the conditional reconfiguration, e.g., CHO, CPA, CPC, etc.;
whether the condition reconfiguration includes a second conditional reconfiguration and, if so, the type of the second conditional configuration;
number of mobility procedures that have been executed while the conditional reconfiguration has been stored by the UE, e.g., stored conditional reconfigurations are released after having been stored during a predetermined number of executed mobility procedures, with the predetermined number being fixed, based on type of executed mobility procedure and/or stored conditional reconfiguration, etc.;
elapsed time since the conditional reconfiguration was received from the network and stored;

state of the target cell (or cell group) after execution of the mobility procedure, e.g., whether target PSCell/SCG is activated or deactivated after execution of a PSCell addition or a PSCell change procedure;
state of the candidate target cell associated with the conditional reconfiguration, e.g., whether the candidate target PSCell is configured to be activated or deactivated after execution of a CPC or CPA procedure; and
correspondence between a configuration for the executed mobility procedure and the conditional reconfiguration, e.g., whether the two configurations have matching indications that the conditional reconfiguration is stored/maintained after execution of the mobility procedure (otherwise it is released).

Embodiments also include corresponding techniques for a RAN node to configure a UE to maintain or release a stored conditional reconfiguration upon or after execution of a mobility procedure towards a target cell, and/or to indicate to the UE (during or after execution of the mobility procedure) which stored conditional reconfigurations should be maintained (or released). Embodiments also include corresponding techniques for a UE to inform a RAN node of the UE's capabilities for maintaining stored conditional configurations after execution of a mobility procedure towards a target cell.

Embodiments can provide various benefits and/or advantages. For example, embodiments provide a UE knowledge about what stored conditional reconfigurations that it should maintain (e.g., to facilitate a subsequent mobility procedure with low delay or latency) after a cell group change procedure. In this manner, both the UE and the network are aware of the conditional reconfigurations that the UE is evaluating at a given moment, which prevents configuration mismatches between UE and network. This also prevents unnecessary reconfiguration failures due to the network assuming the UE is operating with a different configuration (e.g., SCG configuration) than it actually is.

In various embodiments, configuration of a CPC can be performed using the same RRC IEs as CHO, such that these different procedures may be referred to collectively as conditional configuration or conditional reconfiguration. In any case, such a configuration provides triggering/execution condition(s) and an RRCReconfiguration message to be applied when the triggering condition(s) are fulfilled.

FIG. 10A shows an exemplary ASN.1 data structure for a ConditionalReconfiguration IE, which is used to add, modify, and release conditional configurations. Within this IE, the condConfigToAddModList IE is a list of the configurations of candidate SpCells to be added or modified for CHO or CPC.

FIG. 10B shows an exemplary ASN.1 data structure for a condConfigToAddModList IE. Each configuration is included in a CondConfigToAddMod field, which include a condExecutionCond sub-field and a condRRCReconfig sub-field. The condExecutionCond sub-field provides the execution condition that needs to be fulfilled to trigger the execution of the conditional configuration, which is included in the condRRCReconfig sub-field. Both sub-fields are mandatory present when a condConfigId is being added. Otherwise, when the condRRCReconfig associated with a condConfigId is being modified the sub-fields are optionally present and the UE uses the stored value when the sub-fields are absent.

Likewise, the field condConfigToRemoveList is a list of the configuration of candidate SpCells to be removed. When the network removes the stored conditional configuration for a candidate cell, the network releases the measID(s) associated with the condExecutionCond if it is not used by the condExecutionCond of other candidate cells.

FIG. 10C shows an exemplary ASN.1 data structure for the CondConfigId field of the ConditionalReconfiguration IE shown in FIG. 10A. This field identifies a CHO configuration or a CPC configuration by an integer value.

The IEs, fields, and sub-fields shown in FIGS. 10A-C can be used differently in various embodiments, sometimes generated by the MN, sometimes generated by the source SN, sometimes by a target candidate SN. For example, a CPC configuration can be considered as “MN format” when it is not configured as an MR-DC configuration in mrde-SecondaryCellGroup (as defined in 3GPP TS 38.331). In other words, the UE receives an RRCReconfiguration from the MN that may contain the mrdc-SecondaryCellGroup (e.g., in case the UE is also configured with an SCGMeasConfig for inter-SN CPC), but the CPC configuration is not within that container. In such case, the contents of the ConditionalReconfiguration IE illustrated in FIGS. 10A-C are not included in mrde-SecondaryCellGroup.

Similarly, a CPC configuration can be considered as “SN format” when it is configured as an MR-DC configuration in mrde-SecondaryCellGroup (as defined in 3GPP TS 38.331). In other words, the UE receives an RRCReconfiguration from the MN that may contain the mrdc-SecondaryCellGroup and the CPC is within that container. In such case, the contents of the ConditionalReconfiguration IE illustrated in FIGS. 10A-C are included in mrdc-SecondaryCellGroup (e.g., within a series of other nested IEs/fields/sub-fields).

The description of the various embodiments refers to actions performed by a UE after execution of a mobility procedure towards a target cell. The executed mobility procedure can be any of the following: CHO, CPC, CPA, non-conditional HO, non-condition PSCell change, non-conditional PSCell addition, cell group addition, cell group modification, cell group release, etc. The executed mobility procedure may be associated with and/or produce a state change for a part of the UE configuration, e.g., an SCG state change from deactivated to activated (or vice versa), a state change for one or more SCells, etc. The execution of the mobility procedure may or may not include the UE performing a reconfiguration with sync procedure (with or without performing a random access procedure towards the (target) cell).

In some embodiments, the UE determines to maintain or release a stored conditional reconfiguration after execution of a mobility procedure based on an indication from the network. For example, the indication can have two values, one associated with maintaining and another associated with releasing. As another example, presence of the indication can be associated with maintaining and above of the indication can be associated with releasing, or vice versa.

In some embodiments, the indication to maintain or release the stored conditional reconfiguration at execution of a mobility procedure can be included in, or associated with, the corresponding conditional reconfiguration that is to be maintained or released. In other embodiments, the indication(s) whether to maintain or release the stored conditional reconfiguration(s) are included in, or associated with, the configuration for the executed mobility procedure. For example, the UE receives the indication(s) from the network in a message (e.g., RRCReconfiguration) that configures a HO, a PSCell change, a PSCell addition, or a PSCell/SCG release. As another example, the UE receives the indication(s) from the network in a message (e.g., RRCReconfiguration) that reconfigures the SCG state, e.g., from deactivated to activated or vice versa.

In some embodiments, the indication(s) whether to maintain or release the stored conditional reconfiguration can be dependent on the target cell of the executed mobility procedure. For example, different target cells can have different indications or indication values. The indication can then be provided (or set to a specific value) for a subset of the possible target cells for the executed mobility procedure and be absent or set to a different value for another subset of possible target cells.

In some embodiments, the UE determines whether to maintain a stored conditional reconfiguration after execution of a mobility procedure based on a combination of an indication associated with the conditional configuration and an indication associated with the configuration for the executed mobility procedure. For example, the UE determines to maintain a conditional configuration only if the indication value for the conditional configuration is the same as the indication value for the executed mobility procedure.

In some embodiments, the UE determines whether to maintain a stored conditional reconfiguration (e.g., for CPC) after execution of a mobility procedure based on whether the conditional reconfiguration includes a delta configuration or an indication to release and then add the SCG configuration, e.g., by presence of mrdc-Release AndAdd in RRCReconfiguration message that is included in the conditional reconfiguration. For example, the UE releases the stored conditional reconfiguration if the RRCReconfiguration message includes a delta configuration and maintains the stored conditional configuration if the RRCReconfiguration message includes the indication. In some variants, the network can selectively enable this determination by the UE, e.g., via a dedicated RRC message or broadcast message. For example, the dedicated RRC message can be an RRCReconfiguration message as defined in 3GPP TS 38.331 (v17.0.0) or RRC ConnectionReconfiguration as defined in 3GPP TS 36.331 (v17.0.0).

In some embodiments, the UE determines whether to maintain a stored conditional reconfiguration (e.g., for CPC) after execution of a mobility procedure based on whether the conditional reconfiguration includes a full configuration (e.g., as indicated through presence of fullConfig in the corresponding RRC Reconfiguration message that is included in the conditional reconfiguration) or a delta configuration. For example, the UE releases the stored conditional reconfiguration if the RRCReconfiguration message includes a delta configuration and maintains the stored conditional configuration if the RRCReconfiguration message includes a full configuration. In some variants, the network can selectively enable this determination by the UE, e.g., via a dedicated RRC message or broadcast message. For example, the dedicated RRC message can be an RRC Reconfiguration message as defined in 3GPP TS 38.331 (v17.0.0) or RRCConnectionReconfiguration as defined in 3GPP TS 36.331 (v17.0.0).

In some embodiments, the UE determines whether to maintain a stored conditional reconfiguration (e.g., for CPC) after execution of a mobility procedure based on an implicit indication, such as whether that conditional reconfiguration contains another conditional reconfiguration. For example, the UE releases the stored conditional reconfiguration if it includes another conditional reconfiguration and maintains the stored conditional reconfiguration if it does not include another conditional reconfiguration. As another example, the implicit indication can be a type of mobility procedure associated with the conditional reconfiguration, such as CHO, CPA, or CPC. For example, the UE releases the stored conditional reconfiguration if it is associated with CPA or CPC and maintains the stored conditional reconfiguration if it is associated with CHO. In some variants, the UE can identifies type of associated mobility procedure based on the reconfiguration (e.g., condRRCReconfig field) that is included in the conditional reconfiguration, such as e.g., whether it includes a reconfiguration with sync for the MCG, for the SCG, or for both.

As another example, the implicit indication can be a release or version associated with the included reconfiguration, e.g., a 3GPP Rel-16 CPC configuration, a 3GPP Rel-17 CPC configuration, or a 3GPP Rel-18 CPC configuration, an inter-SN CPC, an intra-SN CPC configuration, etc. For example, the UE identifies the release or version based on a release-specified field in the conditional reconfiguration.

As another example, the implicit indication can be a configured state of the candidate target cell within the conditional reconfiguration, e.g., whether a CPA or CPC configuration includes a candidate target PSCell/SCG that is configured to be activated or deactivated after execution of the procedure. In case the state of the PSCell/SCG is deactivated after execution of the conditional PSCell addition or change procedure, the UE may then perform the procedure without any reconfiguration with sync or random access towards the target PSCell.

In some embodiments, the UE determines whether to maintain a stored conditional reconfiguration (e.g., for CPC) after execution of a mobility procedure based on the number of mobility procedures executed by the UE while the conditional reconfiguration has been maintained (i.e., not released). For example, the UE maintains the stored conditional reconfiguration after execution of the first X mobility procedures and then releases it upon the after execution of mobility procedure X+1. The number X can be specified (such that it is known to UEs with this capability), pre-configured as a UE-specific parameter, or configured by the network via dedicated or broadcast signaling.

In some embodiments, the UE determines whether to maintain a stored conditional reconfiguration (e.g., for CPC) after execution of a mobility procedure based on the number of conditional reconfigurations that have been applied/executed by the UE while the conditional reconfiguration has been maintained (i.e., not released). For example, when the UE has applied Y stored conditional reconfigurations, the UE releases all remaining stored conditional reconfigurations. The number Y can be specified (such that it is known to UEs with this capability), pre-configured as a UE-specific parameter, or configured by the network via dedicated or broadcast signaling.

One possible implementation of the above embodiments is by a counter K at the UE. The counter is initialized to zero when the UE receives at least one conditional reconfiguration for at least one candidate cell (e.g., to add, remove and/or modify a candidate cell). At every execution of a mobility procedure (or conditional mobility procedure) the counter is incremented. The UE compares the counter value after mobility procedure execution with a max_counter_value_Kmac (representing X or Y above) obtained by the UE in any of the ways described above.

In some embodiments, the UE determines whether to maintain a stored conditional reconfiguration (e.g., for CPC) after execution of a mobility procedure based on a duration T since the UE received/stored the conditional reconfiguration. For example, the UE maintains the stored conditional reconfiguration for all mobility procedures that are executed before T and releases the stored conditional reconfiguration upon the first mobility procedure executed after T. Alternately, the UE can release the stored conditional reconfiguration after T, independent of mobility procedure execution.

The duration T can be specified (such that it is known to UEs with this capability), pre-configured as a UE-specific parameter, or configured by the network via dedicated or broadcast signaling. For example, T is configured in (or associated with) the conditional reconfiguration, whereby different time values T can be used for different conditional reconfigurations.

In some embodiments, the UE determines whether to maintain a stored conditional reconfiguration (e.g., for CPC) after execution of a mobility procedure based on type of executed mobility procedure. For example, the UE maintains the stored conditional reconfiguration if the executed mobility procedure is a HO or CHO but releases the stored conditional reconfiguration if the executed mobility procedure is a PSCell change, a CPC, a PSCell addition, or a CPA. As noted, these combinations of types is merely an example and other combinations of types of executed mobility procedures that trigger releasing or maintaining stored conditional reconfiguration(s) are also possible.

In some embodiments, the UE determines whether to maintain a stored conditional reconfiguration (e.g., for CPC) after execution of a mobility procedure based on state of the target cell after execution of the mobility procedure. For example, if the UE executes a PSCell addition (or CPA) or PSCell change (or CPC) procedure, the UE determines whether to maintain or release the stored conditional reconfiguration based on whether the target PSCell/SCG is activated or deactivated after the procedure.

In some embodiments, the UE maintains a stored conditional reconfiguration until a next security key update is performed. When a reconfiguration procedure that includes a security key update is performed, the UE then releases the stored conditional reconfiguration.

In some embodiments, the UE determines whether to maintain or release a stored conditional reconfiguration depending on the particular target cell for the executed mobility procedure. For example, the UE can maintain the stored conditional reconfiguration for a first subset of possible target cells and release the stored conditional reconfiguration for a second subset of possible target cells. In some variants, each stored conditional reconfiguration can be associated with different first and second subsets, or at least can be configured with first and second subsets independent of other conditional reconfigurations.

The above embodiments may be combined in various ways. For example, the UE determines whether to maintain a stored conditional reconfiguration (e.g., for CPC) after execution of a mobility procedure based on the type of conditional reconfiguration (e.g., CHO, CPC, or CPA) and the target cell of the executed mobility procedure.

A UE that only supports 3GPP Rel-16 and/or Rel-17 conditional reconfiguration procedures (e.g., CHO, CPC, CPA) but not newly defined Rel-18 procedures releases the stored conditional reconfigurations when it executes another conditional or non-conditional reconfiguration, as discussed above. In case the network then assumes that such a UE stores the conditional reconfigurations after execution of another mobility procedure there will then be a mismatch between the UE and the network regarding what conditional reconfigurations that the UE has stored, which can lead to different errors. In some embodiments, a UE can indicate to the network that it supports maintaining stored conditional reconfigurations after execution of a mobility procedure, e.g., as part of the UE capability information.

In some embodiments, a UE gets an indication from the network to maintain a conditional reconfiguration after execution of a mobility procedure, e.g., after execution of another conditional reconfiguration. The indication may then tell the UE whether to maintain or release a specific conditional reconfiguration, or a set of conditional reconfigurations. In one alternative the UE gets the indication from a target node of the executed conditional reconfiguration. The indication may e.g., be received in an RRC message (e.g., an RRC Reconfiguration message or a new RRC message), in a MAC CE or in a DCI. For example, the UE gets the indication from the network after successfully performing random access towards the target node/cell of the executed conditional reconfiguration.

In some embodiments, a UE maintains other stored conditional reconfiguration(s) after execution of a first conditional reconfiguration until receiving an indication from the network (e.g., a target node of the first conditional reconfiguration) whether to maintain or release the other stored conditional reconfiguration(s). In other embodiments, the UE releases the other conditional reconfiguration(s) unless it receives an indication from the network to maintain them, e.g., within a predetermined duration after execution of the first conditional reconfiguration.

In some variants, the UE refrains from evaluating execution conditions for the other stored conditional reconfiguration(s) after execution of the first conditional reconfiguration, until receiving an indication from the network (e.g., a target node of the first conditional reconfiguration) whether to maintain or release the other stored conditional reconfiguration(s). Once the UE receives an indication to maintain the stored conditional reconfigurations, it resumes evaluation of the execution conditions.

In other variants, the UE continues evaluating execution conditions for the other stored conditional reconfiguration(s) after execution of the first conditional reconfiguration, until receiving an indication from the network (e.g., a target node of the first conditional reconfiguration) whether to maintain or release the other stored conditional reconfiguration(s). In case execution conditions are fulfilled before the UE receives the indication from the network, the UE refrains from execution of the associated conditional reconfiguration until receiving an indication from the network that the conditional reconfiguration should be maintained. In such case, the UE may evaluate whether the execution condition is still valid after receiving the indication.

In some embodiments, the UE provides information to assist the network in configuring the UE for maintaining or releasing stored conditional reconfigurations after UE execution of a mobility procedure. In different variants, the UE can provide such information to the target MN of the executed mobility procedure (e.g., HO or CHO) or to the target SN of the executed mobility procedure (e.g., PSCell Change, CPC, PSCell Addition, CPA, CHO with SCG configuration). In some variants, the UE can provide such information to the MN which then sends the information to the SN. For example, the UE can send such information as part of (or together with) an RRC ReconfigurationComplete message.

In some embodiments, the information provided by the UE to assist the network in configuring the UE for maintaining or releasing stored conditional reconfigurations can include a list of the UE's stored conditional reconfigurations and related information, such as:
identity of conditional reconfiguration (CondReconfigID);
identifiers of one or more candidate target cells for the conditional reconfiguration, e.g., frequency and Physical Cell Identity (PCI);
execution conditions for the conditional reconfiguration, possibly including a measurement configuration;
conditional reconfiguration type, e.g., CHO, CPA, CPC, etc.;
whether the conditional reconfiguration is a full configuration (e.g., as indicated through presence of fullConfig in the corresponding RRC Reconfiguration message) or a delta configuration;
whether the conditional reconfiguration includes an indication to release and then add the SCG configuration (e.g., as indicated through presence of mrdc-Release AndAdd in the corresponding RRC Reconfiguration message) or includes a delta configuration for the SCG.

In some embodiments, the information provided by the UE to assist the network in configuring the UE for maintaining or releasing stored conditional reconfigurations can include measurement results for the candidate target cells of the stored conditional reconfigurations.

In some embodiments, a UE can indicate to the network that it supports maintaining stored conditional reconfigurations after execution of a mobility procedure based on providing any of the above-described information to assist the network. In other embodiments, the UE explicitly indicates to the network that it supports maintaining stored conditional reconfigurations and/or that it has stored conditional reconfigurations, without providing such assistance information.

Other embodiments include various techniques for RAN nodes to configure a UE with information about conditional reconfigurations to be maintained at execution of another mobility procedure, to indicate to other RAN nodes what conditional reconfigurations that the UE has stored, and to provide information to assist the other RAN nodes in configuring a UE to maintain or release stored conditional reconfigurations after execution of a mobility procedure. In some embodiments, the MN provides to each candidate target SN (T-SN) for CPC a list of all candidates T-SNs and/or all candidate PSCells (e.g., in the CG-ConfigInfo IE included in a S-NODE ADDITION REQUEST message) associated with conditional reconfigurations stored by the UE. For example, the candidate cells can be identified by carrier frequency and PCI. In a variant, the MN provides a list of candidates T-SNs and/or candidate PSCells that are associated with stored conditional reconfigurations that the UE should maintain after execution of any mobility procedure. In a variant, the MN provides a list of candidates T-SNs and/or candidate PSCells that are associated with stored conditional reconfigurations that the UE should maintain after execution of the CPC that is being configured by the MN (i.e., to that candidate T-SN).

In some embodiments, the MN has received information from the UE's current (source) SN about the other candidate T-SNs and/or candidate PSCells, based on which the MN can provide any of the lists mentioned above. For example, the S-SN provides this information to the MN in the S-NODE CHANGE REQUIRED message that is used for configuration of the CPC procedure.

In some embodiments, a candidate T-SN, when receiving an S-NODE ADDITION REQUEST message with one of these lists, combines the received list with other available information (e.g., neighbor cell relations towards the other candidate PSCells, connections towards the other candidate T-SNs, operator configuration, etc.) to determine which conditional reconfigurations for other candidate T-SNs/PSCells the UE should maintain in case the UE executes the MN-configured mobility procedure (e.g., CPC) to the candidate target cell (PSCell) of the candidate T-SN. In one alternative, the T-SN includes the information about other conditional reconfigurations to be maintained within the target SCG configuration, to be included in the conditional reconfiguration (e.g., within a CPC configuration). In another alternative, the candidate T-SN provides this information to the MN together with the target SCG configuration, e.g., in the S-NODE ADDITION REQUEST ACKNOWLEDGE message. The MN can then provide the information to the UE within, or together with, the conditional reconfiguration (e.g., the CPC configuration) for the candidate target cell (PSCell) served by the candidate T-SN.

In some embodiments, a candidate T-SN serving a candidate target cell (PSCell), based on receiving a message with one of these lists, determines whether the UE should maintain the conditional reconfiguration of that candidate target cell after the UE executes the MN-configured mobility procedure to other candidate target cells. In one alternative, the candidate T-SN sends the UE an indication of which other target cells (e.g., target PSCells) for which the UE should maintain the conditional reconfiguration provided by the candidate T-SN, after execution of a mobility procedure towards any of the indicated target cells. For example, the T-SN includes this information within the target SCG configuration to be included within the conditional reconfiguration provided to the UE.

In another alternative, the T-SN provides this information to the MN together with the target SCG configuration, e.g., in the S-NODE ADDITION REQUEST ACKNOWLEDGE message. The MN can then provide the information to the UE within, or together with, the conditional reconfiguration (e.g., the CPC configuration) for the related candidate PSCell in the candidate T-SN.

In some embodiments, each candidate T-SN sends the MN information about which conditional reconfigurations (and/or associated candidate cells) should be maintained by the UE, such as in the CG-CandidateList IE that is included in the S-NODE ADDITION REQUEST ACKNOWLEDGE message. For example, candidate cells can be identified by carrier frequency and PCI. In some variants, each candidate T-SN includes other information such as how long the conditional reconfiguration should be maintained, a number (X) of mobility procedures during which the conditional reconfiguration should be maintained, etc.

In some embodiments, the MN receives, from each candidate T-SN, a list of other candidate target cells whose associated conditional reconfigurations should be maintained by the UE after executing the conditional configurations provided by that candidate T-SN. The MN stores this information and performs a mapping between the candidate cell identities (e.g., frequency and PCI) and conditional reconfiguration identifiers (CondReconfigID).

In some embodiments, the MN includes, with each conditional reconfiguration sent to the UE in the RRCReconfiguration, a list of other candidate cells whose associated conditional reconfigurations should be maintained by the UE after executing the conditional configuration. This can be provided, for example, as a list of CondReconfigID).

In some embodiments, the MN sends to the candidate target node for a conditional reconfiguration (e.g., T-SN for CPC or CPA, T-MN for CHO) some information about the other conditional reconfigurations that the UE has stored. This is useful for the candidate target node in case the UE executes that conditional reconfiguration, at which point it becomes the target node. In some variants, the MN may provide information about only a relevant subset of the conditional reconfigurations stored by the UE. For example, the MN may send information about other CPC or CPA configurations to a candidate T-SN.

In one alternative, the MN sends the information about conditional reconfigurations that the UE has stored to the target node for UE execution of a conditional reconfiguration (e.g., a T-SN of a CPC or CPA configuration being executed). For example, the MN can send this information to the T-SN in (or together with) an S-NODE Reconfiguration Complete message.

In some embodiments, the information provided by the MN to assist the target node's configuring the UE for maintaining or releasing stored conditional reconfigurations, after UE execution of a conditional or non-conditional mobility procedure, can include a list of the UE's stored conditional reconfigurations and related information, such as:
identity of conditional reconfiguration (CondReconfigID);
identifiers of one or more candidate target cells for the conditional reconfiguration, e.g., frequency and Physical Cell Identity (PCI);
execution conditions for the conditional reconfiguration, possibly including a measurement configuration;
conditional reconfiguration type, e.g., CHO, CPA, CPC, etc.;
whether the conditional reconfiguration is a full configuration (e.g., as indicated through presence of fullConfig in the corresponding RRC Reconfiguration message) or a delta configuration;
whether the conditional reconfiguration includes an indication to release and then add the SCG configuration (e.g., as indicated through presence of mrdc-Release AndAdd in the corresponding RRC Reconfiguration message) or includes a delta configuration for the SCG.

In some embodiments, the information provided by the MN to assist the target node's configuring the UE for maintaining or releasing stored conditional reconfigurations can include UE measurement results for the candidate target cells of the stored conditional reconfigurations.

In some embodiments, the information provided by the MN to assist the target node's configuring the UE for maintaining or releasing stored conditional reconfigurations can include an indication of UE support (e.g., capabilities) for storing conditional reconfigurations after execution of a mobility procedure.

In one alternative, the target node of an executed mobility procedure uses the information to determine what conditional reconfigurations that the UE should maintain and what conditional reconfigurations that it should release. The target node of the executed mobility procedure then informs the UE about what conditional reconfigurations that it shall maintain and what to release, e.g., using an RRC message or a MAC CE. For example, the target node sends the information about what conditional reconfigurations to maintain and what to release in an RRCReconfiguration message.

In some embodiments, the MN sends the information about conditional reconfigurations that the UE has stored (or about some of them) to the target node for a non-conditional mobility procedure, i.e., a procedure that is to be executed at reception of the configuration. As an example, the MN sends the information to the target MN in case of a normal handover procedure or to the target SN in case of a normal PSCell addition or PSCell change procedure. For example, the MN then includes the information to the target node together with the request to perform the procedure, e.g., in the HANDOVER REQUEST message when requesting a target MN for a handover, or in the S-NODE ADDITION REQUEST message when requesting a PSCell addition or a PSCell change procedure.

In one alternative, the target node of the non-conditional mobility procedure uses the information to determine what conditional reconfigurations that the UE should maintain and what conditional reconfigurations that it should release. The target node then informs the UE about what conditional reconfigurations that it shall maintain and what to release, in the message that is used to configure the mobility procedure, e.g., the target MN in case of a handover procedure includes it in the RRC Reconfiguration message that corresponds to the Handover Command, or the target SN in case of a PSCell addition or PSCell change procedure includes it in the corresponding RRC Reconfiguration message that includes the corresponding new SCG configuration.

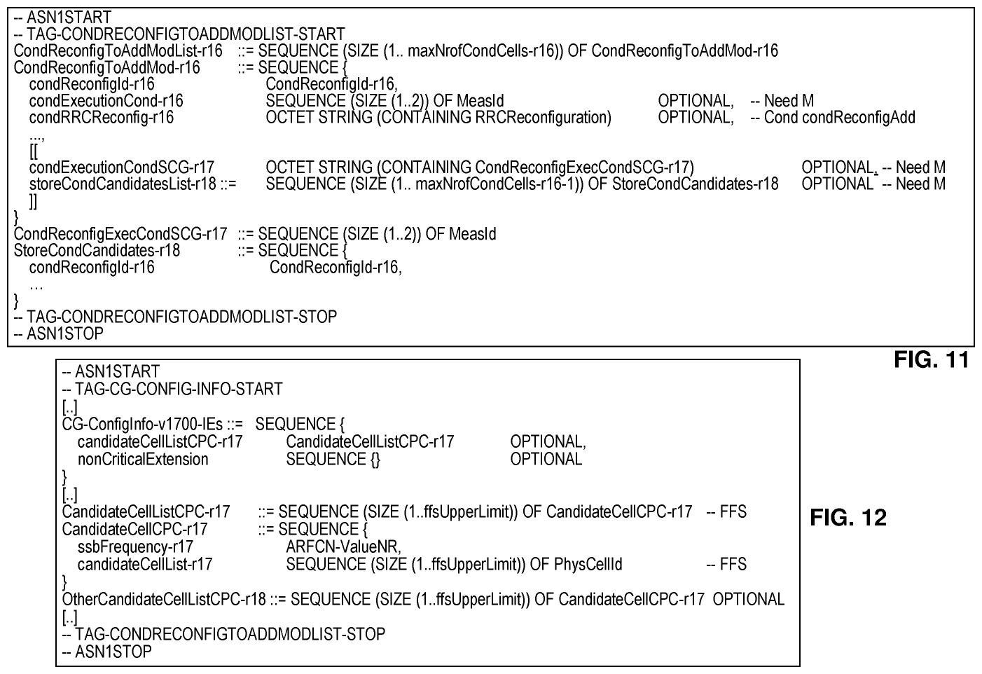

FIG. 11 shows an exemplary ASN.1 data structure for a CondReconfigToAddModList IE, according to some embodiments of the present disclosure. This IE is similar to the CondReconfigToAddModList IE shown in FIG. 10B, except that each CondReconfigToAddMod IE within it also includes a StoreCondCandidatesList field. This field contains a list of other conditional reconfigurations that the UE should maintain after executing the condRRCReconfig included in the same CondReconfigToAddMod IE. Each entry in the list is an identifier associated with a conditional configuration, e.g., stored by the UE.

FIG. 12 shows an exemplary ASN.1 data structure for a CG-ConfigInfo message, according to some embodiments of the present disclosure. This message is used by MN to request an SN to perform certain actions such as establish, modify, or release an SCG. The message may include additional information to assist the SN in setting the SCG configuration. This exemplary message includes an OtherCandidateCellListCPC IE, which is a sequence of CandidateCellCPC fields, each indicating a candidate target cell whose conditional reconfiguration should be maintained after UE execution of a mobility procedure.

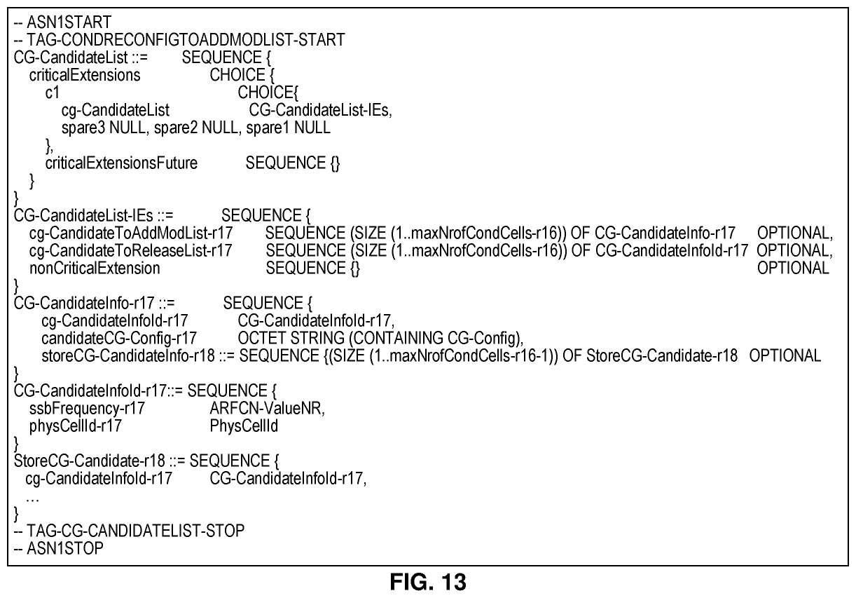

FIG. 13 shows an exemplary ASN.1 data structure for a CG-CandidateList message, according to some embodiments of the present disclosure. This message is used by a candidate T-SN to transfer the SCG radio configuration for one or more candidate target cells for CPA or CPC. This exemplary message includes a store (G-CandidateInfo IE, which is a sequence of StoreCG-Candidate fields, each indicating another candidate target cell whose conditional reconfiguration should be maintained after UE execution of the CPC or CPA being configured.

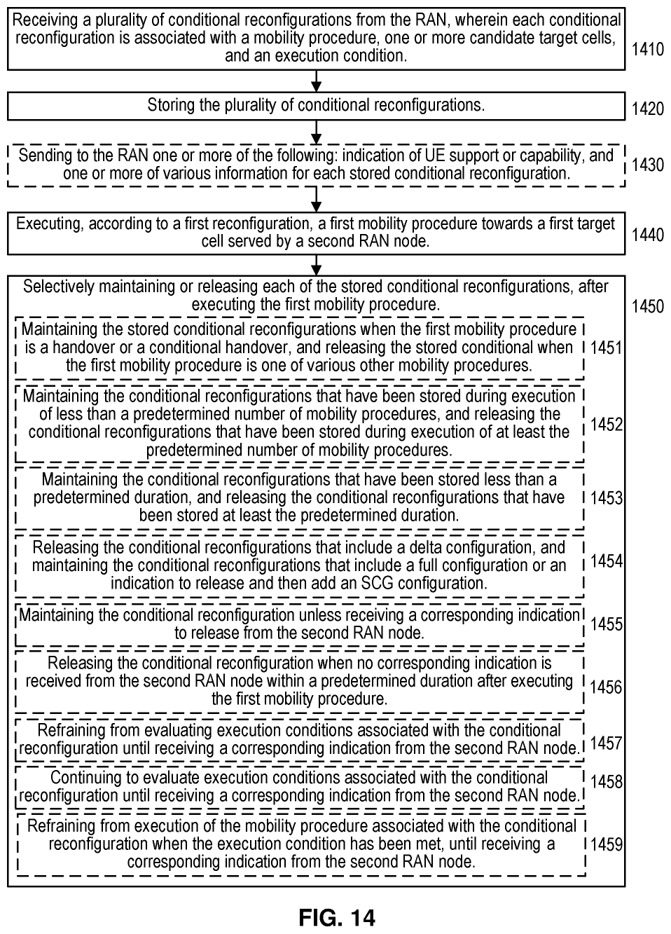

The embodiments described above can be further illustrated with reference to FIGS. 14-16, which show exemplary methods (e.g., procedures) performed by a UE, a first RAN node, and a second RAN node, respectively. In other words, various features of operations described below correspond to various embodiments described above. These exemplary methods can be used cooperatively to provide various exemplary benefits and/or advantages. Although FIGS. 14-16 show specific blocks in a particular order, the operations of the respective methods can be performed in different orders than shown and can be combined and/or divided into blocks having different functionality than shown. Optional blocks or operations are indicated by dashed lines.

In particular, FIG. 14 shows a flow diagram of an exemplary method (e.g., procedure) for a UE configured to communicate with a RAN via at least an MCG, according to various embodiments of the present disclosure. The exemplary method can be performed by a UE (e.g., wireless device, IoT device, modem, etc. or component thereof) such as described elsewhere herein.

The exemplary method includes the operations of block 1410, where the UE can receive a plurality of conditional reconfigurations from the RAN. Each conditional reconfiguration is associated with a mobility procedure, one or more candidate target cells, and an execution condition. The exemplary method can also include operations of block 1420, where the UE can store the plurality of conditional reconfigurations. The exemplary method also includes the operations of block 1440, where the UE can execute, according to a first reconfiguration, a first mobility procedure towards a first target cell served by a second RAN node. The first mobility procedure and the plurality of stored conditional reconfigurations are associated with a same one of the MCG and an SCG for the UE. The exemplary method also includes the operations of block 1450, where the UE can selectively maintain or release each of the stored conditional reconfigurations, after executing the mobility procedure.

In some embodiments, the first mobility procedure towards the first target cell is a handover or a conditional handover (CHO). Each conditional reconfiguration is associated with a conditional handover (CHO), where the candidate target cell is a primary cell (PCell) of an MCG.

In other embodiments, the first mobility procedure towards the first target cell is one of the following: non-conditional primary SCG cell (PSCell) change, non-conditional PSCell addition, SCG addition, SCG modification, and SCG release. Also, each conditional reconfiguration is associated with one of the following mobility procedures:
conditional primary SCG cell (PSCell) addition (CPA), wherein the candidate target cell is a PSCell of an SCG; and
conditional PSCell change (CPC), wherein the candidate target cell is a PSCell of an SCG.

In other embodiments, the first mobility procedure towards the first target cell is a CPA or a CPC, and each conditional reconfiguration is associated with one of the following mobility procedures:
CPA, wherein the candidate target cell is a PSCell of an SCG; or
CPC, wherein the candidate target cell is a PSCell of an SCG.

In some embodiments, selectively maintaining or releasing each of the stored conditional reconfigurations in block 1450 is based on one or more of the following:
an indication received from the RAN in relation to the first mobility procedure;
content of the stored conditional reconfiguration;
content of one or more other of the stored conditional reconfigurations;
type of mobility procedure associated with the stored conditional reconfiguration;
identity of the first target cell;
content of the first reconfiguration;
type of the executed first mobility procedure;
number of mobility procedures executed by the UE while the conditional reconfiguration has been stored;
duration that the conditional reconfiguration has been stored;
state of the first target cell, or cell group comprising the first target cell, after execution of the first mobility procedure,
state of a candidate target cell after execution of the corresponding mobility procedure; and
a match or correspondence between one or more parameters of the first configuration and one or more parameters of the conditional reconfiguration.

In some of these embodiments, each conditional reconfiguration includes identifiers of one or more of the following: other conditional reconfigurations that should be maintained by the UE after execution of the associated mobility procedure; other candidate target cells whose associated conditional reconfigurations should be maintained by the UE after execution of the associated mobility procedure; and candidate target nodes that provide candidate target cells whose associated conditional reconfigurations should be maintained by the UE after execution of the associated mobility procedure.

In some of these embodiments, each conditional reconfiguration includes an indication of whether a state of candidate target cell after execution of the associated mobility procedure is activated or deactivated, and selectively maintaining or releasing each of the stored conditional reconfigurations in block 1450 is based on the indicated state of the candidate target cell after execution of the associated mobility procedure.

In some of these embodiments, the first reconfiguration includes an indication of whether a state of the first target, or of a cell group comprising the first target cell, is activated or deactivated after execution of the first mobility procedure. In such case, selectively maintaining or releasing the stored conditional reconfigurations in block 1450 is based the indicated state of the first target cell, or of the cell group comprising the first target cell, after execution of the first mobility procedure.

In some embodiments, the first configuration is one of the stored conditional reconfigurations, which is associated with the first mobility procedure and the first target cell. In some of these embodiments, selectively maintaining or releasing each of the stored conditional reconfigurations in block 1450 includes the operations of sub-block 1451, where the UE can maintain the stored conditional reconfigurations when the first mobility procedure is a handover or a conditional handover, and release the stored conditional when the first mobility procedure is one of the following: a non-conditional PSCell change, a CPC, a non-conditional PSCell addition, or a CPA.

In some embodiments, selectively maintaining or releasing each of the stored conditional reconfiguration in block 1450 includes the operations of sub-block 1452, where the UE can maintain the conditional reconfigurations that have been stored during execution of less than a predetermined number of mobility procedures, and release the conditional reconfigurations that have been stored during execution of at least the predetermined number of mobility procedures.

In other embodiments, selectively maintaining or releasing each of the stored conditional reconfiguration in block 1450 includes the operations of sub-block 1453, where the UE can maintain the conditional reconfigurations that have been stored less than a predetermined duration, and release the conditional reconfigurations that have been stored during execution of at least the predetermined duration.

In other embodiments, selectively maintaining or releasing each of the stored conditional reconfiguration in block 1450 includes the operations of sub-block 1454, where the UE can release the conditional reconfigurations that include a delta configuration, and maintain the conditional reconfigurations that include a full configuration or an indication to release and then add an SCG configuration.

In other embodiments, for each of the stored conditional reconfigurations, selectively maintaining or releasing the stored conditional reconfiguration in block 1450 is based on one of the following: one or more indications received from a first RAN node before execution of the first mobility procedure; or one or more indications received from the second RAN node after execution of the first mobility procedure. In some of these embodiments, the one or more indications include a plurality of indications corresponding to the respectively plurality of stored conditional reconfigurations. In other of these embodiments, the one or more indications include a single indication that applies to the plurality of stored conditional reconfigurations. In such embodiments, selectively maintaining or releasing the stored conditional reconfigurations is based on the single indication.

In some of these embodiments, for each of the stored conditional reconfigurations, selectively maintaining or releasing the conditional reconfiguration after executing the mobility procedure in block 1450 includes one or more of the following, labelled with corresponding sub-block numbers:
(1455) maintaining the conditional reconfiguration unless receiving a corresponding indication to release from the second RAN node;
(1456) releasing the conditional reconfiguration when no corresponding indication is received from the second RAN node within a predetermined duration after executing the first mobility procedure;
(1457) refraining from evaluating execution conditions associated with the conditional reconfiguration until receiving a corresponding indication from the second RAN node;
(1458) continuing to evaluate execution conditions associated with the conditional reconfiguration until receiving a corresponding indication from the second RAN node; and
(1459) refraining from execution of the mobility procedure associated with the conditional reconfiguration when the execution condition has been met, until receiving a corresponding indication from the second RAN node.

In other embodiments, for each of the stored conditional reconfigurations, selectively maintaining or releasing the conditional reconfiguration after executing the mobility procedure in block 1450 is based on one or more of the following:
whether the conditional reconfiguration includes a further conditional reconfiguration and if so, a type of the further conditional configuration;
whether both the conditional reconfiguration and the first reconfiguration include an indication that the conditional reconfiguration is maintained after execution of the mobility procedure.

In some embodiments, the exemplary method can also include the operations of block 1430, where the UE can send to the RAN one or more of the following information:
an indication of UE support or capability for maintaining stored conditional reconfigurations after execution of a mobility procedure; and.
for each of the stored conditional reconfigurations, one or more of the following:
   identifier of the conditional reconfiguration;
   identifiers of the associated one or more candidate target cells;
   the execution conditions associated with the conditional reconfiguration;
   a measurement configuration associated with the conditional reconfiguration;
   type of the mobility procedure associated with the conditional reconfiguration;
   whether the conditional reconfiguration is a full configuration or a delta configuration;
   whether the conditional reconfiguration includes an indication to release and then add an SCG or includes a delta configuration for the SCG; and
   UE measurement results for the associated one or more candidate target cells.

In some embodiments, the information is sent in block 1420 to a first RAN node that provides the MCG, before executing the first mobility procedure. In other embodiments, the information is sent in block 1420 to the second RAN node after executing the first mobility procedure.

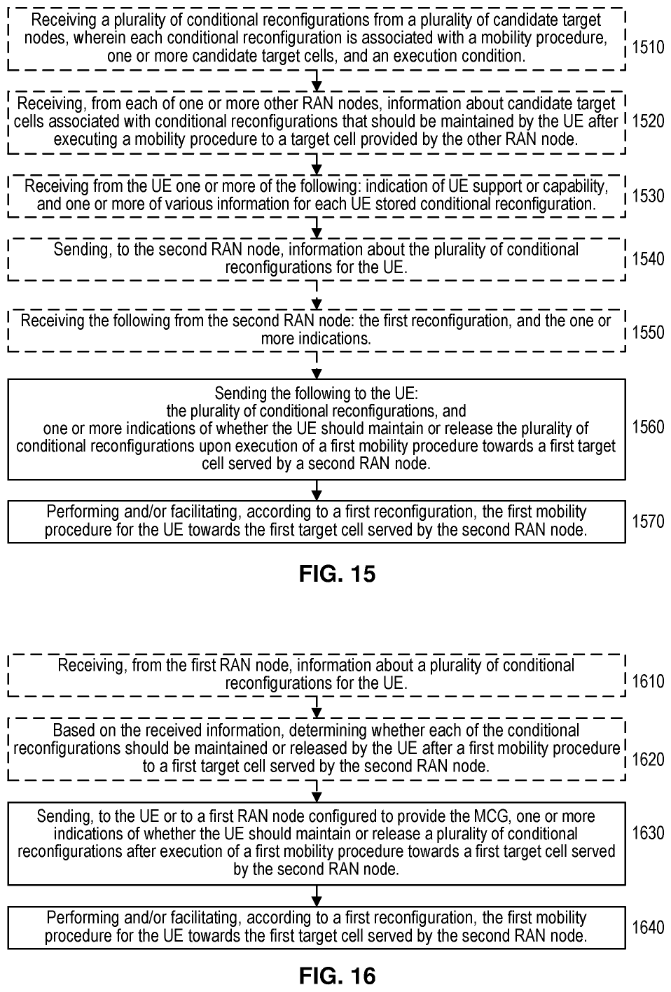

In addition, FIG. 15 shows a flow diagram of an exemplary method (e.g., procedure) for a first RAN node configured to provide an MCG for a UE, according to various embodiments of the present disclosure. The exemplary method can be performed by a RAN node (e.g., base station, eNB, gNB, ng-eNB, en-gNB, etc., or components thereof) such as described elsewhere herein.

The exemplary method includes the operations of block 1560, where the first RAN node can send the following to the UE:
a plurality of conditional reconfigurations, wherein each conditional reconfiguration is associated with a mobility procedure, one or more candidate target cells, and an execution condition; and
one or more indications of whether the UE should maintain or release the plurality of conditional reconfigurations after execution of a first mobility procedure towards a first target cell served by a second RAN node, wherein the first mobility procedure and the plurality of conditional reconfigurations are associated with a same one of the MCG and an SCG for the UE.

The exemplary method also includes the operations of block 1570, where the first RAN node can subsequently perform and/or facilitate, according to a first reconfiguration, the first mobility procedure for the UE towards the first target cell served by the second RAN node.

In some embodiments, the first mobility procedure towards the first target cell is a handover or a conditional handover (CHO). Each conditional reconfiguration is associated with a conditional handover (CHO), where the candidate target cell is a primary cell (PCell) of an MCG.

In other embodiments, the first mobility procedure towards the first target cell is one of the following: non-conditional primary SCG cell (PSCell) change, non-conditional PSCell addition, SCG addition, SCG modification, and SCG release. Also, each conditional reconfiguration is associated with one of the following mobility procedures:
conditional primary SCG cell (PSCell) addition (CPA), wherein the candidate target cell is a PSCell of an SCG; and
conditional PSCell change (CPC), wherein the candidate target cell is a PSCell of an SCG.

In other embodiments, the first mobility procedure towards the first target cell is a CPA or a CPC, and each conditional reconfiguration is associated with one of the following mobility procedures:
CPA, wherein the candidate target cell is a PSCell of an SCG; or
CPC, wherein the candidate target cell is a PSCell of an SCG.

In some embodiments, the exemplary method can include the operations of blocks 1540-1550, where the first RAN node can send to the second RAN node information about the plurality of conditional reconfigurations for the UE and receive the following from the second RAN node: the first reconfiguration, and the one or more indications. In some of these embodiments, the information sent to the second RAN node in block 1540 includes one or more of the following:
an indication of UE support or capability for maintaining stored conditional reconfigurations after execution of a mobility procedure; and
for each conditional reconfiguration stored by the UE, one or more of the following:
   identifier of the conditional reconfiguration;
   identifiers of the associated one or more candidate target cells;
   the execution conditions associated with the conditional reconfiguration;
   a measurement configuration associated with the conditional reconfiguration;
   type of the mobility procedure associated with the conditional reconfiguration;
   whether the conditional reconfiguration is a full configuration or a delta configuration;
   whether the conditional reconfiguration includes an indication to release and then add an SCG or includes a delta configuration for the SCG and
   UE measurement results for the associated one or more candidate target cells.

In some of these embodiments, the exemplary method can also include the operations of block 1530, where the first RAN node can receive from the UE at least a portion of the information sent to the second RAN node in block 1540, or information on which the information sent to the second RAN node is based.

In some of these embodiments, each conditional reconfiguration includes identifiers of one or more of the following:
other conditional reconfigurations that should be maintained by the UE after execution of the associated mobility procedure;
other candidate target cells whose associated conditional reconfigurations should be maintained by the UE after execution of the associated mobility procedure; and
candidate target nodes that provide other candidate target cells whose associated conditional reconfigurations should be maintained by the UE after execution of the associated mobility procedure.

In some embodiments, each conditional reconfiguration includes at least one field associated with a version or release of functionality. The version or release further indicates whether the UE should maintain or release the conditional reconfiguration after execution of a mobility procedure.

In some embodiments, each conditional reconfiguration includes a first indication of whether a state of the associated candidate target cell is activated or deactivated after execution of the associated mobility procedure. Moreover, each first indication further indicates whether the UE should maintain or release the associated conditional reconfiguration after execution of the associated mobility procedure.

In some embodiments, the first reconfiguration includes a second indication of whether a state of the first target cell, or of a cell group comprising the first target cell, is activated or deactivated after execution of the first mobility procedure. Moreover, the second indication further indicates whether the UE should maintain or release the associated conditional reconfiguration after execution of the associated mobility procedure.

In some embodiments, the one or more indications include a single indication that applies to the plurality (i.e., all) of conditional reconfigurations. In other embodiments, the one or more indications include a plurality of indications corresponding to the respectively plurality of conditional reconfigurations.

In some embodiments, the first configuration is one of the conditional reconfigurations for the UE, with the first configuration being associated with the first mobility procedure and the first target cell.

In some embodiments, the exemplary method can also include the operations of block 1520, where the first RAN node can receive, from each of one or more other RAN nodes, information about candidate target cells associated with conditional reconfigurations that should be maintained by the UE after executing a mobility procedure to a target cell provided by the other RAN node.

In some embodiments, the exemplary method can also include the operations of block 1510, where the first RAN node can receive the plurality of conditional reconfigurations (i.e., sent to the UE in block 1560) from a plurality of candidate target nodes. In some of these embodiments, the information that identifies other conditional reconfigurations that should be maintained is included in or with the respective conditional reconfigurations (e.g., received in block 1520).

In addition, FIG. 16 shows a flow diagram of an exemplary method (e.g., procedure) for a second RAN node configured as a target node or a candidate target node for a mobility procedure by a UE, according to various embodiments of the present disclosure. The exemplary method can be performed by a RAN node (e.g., base station, eNB, gNB, ng-eNB, en-gNB, etc., or components thereof) such as described elsewhere herein.

The exemplary method includes the operations of block 1630, where the second RAN node can send, to the UE or to a first RAN node configured to provide an MCG for the UE, one or more indications of whether the UE should maintain or release a plurality of conditional reconfigurations after execution of a first mobility procedure towards a first target cell served by the second RAN node. Each conditional reconfiguration is associated with a mobility procedure, one or more candidate target cells, and an execution condition. Also, the first mobility procedure and the plurality of conditional reconfigurations are associated with a same one of the MCG and an SCG for the UE. The exemplary method also includes the operations of block 1640, where the second RAN node can perform and/or facilitate, according to a first reconfiguration, the first mobility procedure for the UE towards the first target cell served by the second RAN node.

In some embodiments, the first mobility procedure towards the first target cell is a handover or a conditional handover (CHO). Each conditional reconfiguration is associated with a conditional handover (CHO), where the candidate target cell is a primary cell (PCell) of an MCG.

In other embodiments, the first mobility procedure towards the first target cell is one of the following: non-conditional primary SCG cell (PSCell) change, non-conditional PSCell addition, SCG addition, SCG modification, and SCG release. Also, each conditional reconfiguration is associated with one of the following mobility procedures:
conditional primary SCG cell (PSCell) addition (CPA), wherein the candidate target cell is a PSCell of an SCG; and
conditional PSCell change (CPC), wherein the candidate target cell is a PSCell of an SCG.

In other embodiments, the first mobility procedure towards the first target cell is a CPA or a CPC, and each conditional reconfiguration is associated with one of the following mobility procedures:
CPA, wherein the candidate target cell is a PSCell of an SCG; or
CPC, wherein the candidate target cell is a PSCell of an SCG.

In some embodiments, the exemplary method can include the operations of blocks 1610-1620, where the second RAN node can receive from the first RAN node information about the plurality of conditional reconfigurations and, based on the received information, determine whether each of the conditional reconfigurations should be maintained or released by the UE after the first mobility procedure. The one or more indications sent in block 1630 are based on the determination in block 1620.

In some of these embodiments, the information received from the first RAN node (e.g., in block 1610) includes identifiers of one or more of the following:
conditional reconfigurations that should be maintained by the UE after execution of the associated mobility procedure;
candidate target cells whose associated conditional reconfigurations should be maintained by the UE after execution of the associated mobility procedure; and
candidate target nodes that provide candidate target cells whose associated conditional reconfigurations should be maintained by the UE after execution of the associated mobility procedure.

In some of these embodiments, the information received from the first RAN node (e.g., in block 1610) includes one or more of the following:
an indication of UE support or capability for maintaining stored conditional reconfigurations after execution of a mobility procedure; and
for each conditional reconfiguration stored by the UE, one or more of the following:
   identifier of the conditional reconfiguration;
   identifiers of the associated one or more candidate target cells;
   the execution conditions associated with the conditional reconfiguration;
   a measurement configuration associated with the conditional reconfiguration;
   type of the mobility procedure associated with the conditional reconfiguration;
   whether the conditional reconfiguration is a full configuration or a delta configuration;
   whether the conditional reconfiguration includes an indication to release and then add an SCG or includes a delta configuration for the SCG; and
   UE measurement results for the associated one or more candidate target cells.

In some embodiments, the one or more indications are sent to first RAN node (e.g., in block 1630) together with the first reconfiguration, before the first mobility procedure. In other embodiments, the one or more indications are sent to the UE (e.g., in block 1630) after the first mobility procedure. In some embodiments, the one or more indications include a single indication that applies to the plurality of conditional reconfigurations.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

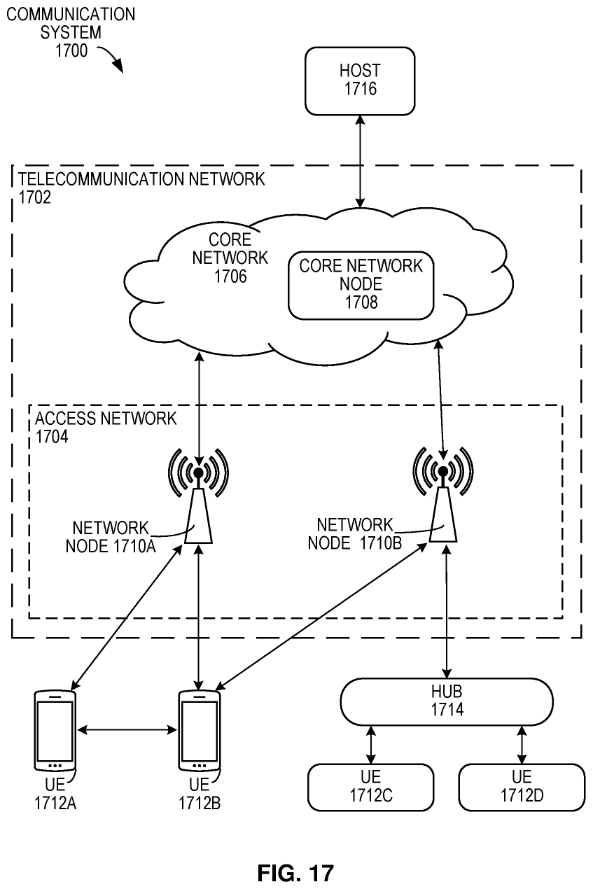

FIG. 17 shows an example of a communication system 1700 in accordance with some embodiments. In this example, communication system 1700 includes a telecommunication network 1702 that includes an access network 1704 (e.g., RAN) and a core network 1706, which includes one or more core network nodes 1708. Access network 1704 includes one or more access network nodes, such as network nodes 1710a-b (one or more of which may be generally referred to as network nodes 1710), or any other similar 3GPP access node or non-3GPP access point.

Network nodes 1710 facilitate direct or indirect connection of UEs, such as by connecting UEs 1712a-d (one or more of which may be generally referred to as UEs 1712) to core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1700 may include any number of wired or wireless networks, network nodes, UEs, and/or any other components or systems that may facilitate or participate in the communication of data and/or signals whether via wired or wireless connections. Communication system 1700 may include and/or interface with any type of communication, telecommunication, data, cellular, radio network, and/or other similar type of system.

UEs 1712 may be any of a wide variety of communication devices, including wireless devices arranged, configured, and/or operable to communicate wirelessly with network nodes 1710 and other communication devices. Similarly, network nodes 1710 are arranged, capable, configured, and/or operable to communicate directly or indirectly with UEs 1712 and/or with other network nodes or equipment in telecommunication network 1702 to enable and/or provide network access, such as wireless network access, and/or to perform other functions, such as administration in telecommunication network 1702.

In the depicted example, core network 1706 connects network nodes 1710 to one or more hosts, such as host 1716. These connections may be direct or indirect via one or more intermediary networks or devices. In other examples, network nodes may be directly coupled to hosts. Core network 1706 includes one or more core network nodes (e.g., 1708) that are structured with hardware and software components. Features of these components may be substantially similar to those described with respect to the UEs, network nodes, and/or hosts, such that the descriptions thereof are generally applicable to the corresponding components of core network node 1708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1716 may be under the ownership or control of a service provider other than an operator or provider of access network 1704 and/or telecommunication network 1702, and may be operated by the service provider or on behalf of the service provider. Host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1700 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1702 is a cellular network that implements 3GPP standardized features. Accordingly, telecommunication network 1702 may support network slicing to provide different logical networks to different devices that are connected to telecommunication network 1702. For example, telecommunication network 1702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1712 are configured to transmit and/or receive information without direct human interaction. For instance, a UE may be designed to transmit information to access network 1704 on a predetermined schedule, when triggered by an internal or external event, or in response to requests from access network 1704. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 1714 communicates with access network 1704 to facilitate indirect communication between one or more UEs (e.g., UE 1712c and/or 1712d) and network nodes (e.g., network node 1710b). In some examples, hub 1714 may be a controller, router, content source and analytics, or any of the other communication devices described herein regarding UEs. For example, hub 1714 may be a broadband router enabling access to core network 1706 for the UEs. As another example, hub 1714 may be a controller that sends commands or instructions to one or more actuators in the UEs. Commands or instructions may be received from the UEs, network nodes 1710, or by executable code, script, process, or other instructions in hub 1714. As another example, hub 1714 may be a data collector that acts as temporary storage for UE data and, in some embodiments, may perform analysis or other processing of the data. As another example, hub 1714 may be a content source. For example, for a UE that is a VR headset, display, loudspeaker or other media delivery device, hub 1714 may retrieve VR assets, video, audio, or other media or data related to sensory information via a network node, which hub 1714 then provides to the UE either directly, after performing local processing, and/or after adding additional local content. In still another example, hub 1714 acts as a proxy server or orchestrator for the UEs, in particular in if one or more of the UEs are low energy IoT devices.

Hub 1714 may have a constant/persistent or intermittent connection to the network node 1710b. Hub 1714 may also allow for a different communication scheme and/or schedule between hub 1714 and UEs (e.g., UE 1712c and/or 1712d), and between hub 1714 and core network 1706. In other examples, hub 1714 is connected to core network 1706 and/or one or more UEs via a wired connection. Moreover, hub 1714 may be configured to connect to an M2M service provider over access network 1704 and/or to another UE over a direct connection. In some scenarios, UEs may establish a wireless connection with network nodes 1710 while still connected via hub 1714 via a wired or wireless connection. In some embodiments, hub 1714 may be a dedicated hub-that is, a hub whose primary function is to route communications to/from the UEs from/to the network node 1710b. In other embodiments, hub 1714 may be a non-dedicated hub-that is, a device which is capable of operating to route communications between the UEs and network node 1710b, but which is additionally capable of operating as a communication start and/or end point for certain data channels.

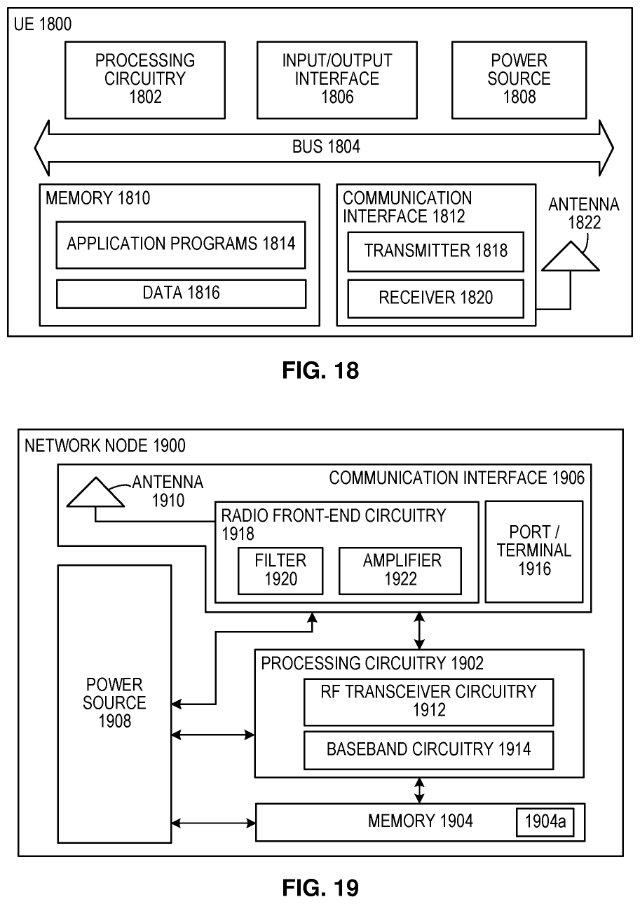

FIG. 18 shows a UE 1800 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1800 includes processing circuitry 1802 that is operatively coupled via a bus 1804 to an input/output interface 1806, a power source 1808, a memory 1810, a communication interface 1812, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

Processing circuitry 1802 is configured to process instructions and data and may be configured to implement any sequential state machine operative to execute instructions stored as machine-readable computer programs in memory 1810. Processing circuitry 1802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1802 may include multiple central processing units (CPUs).

In the example, input/output interface 1806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1808 is structured as a battery or battery pack. Other types of power sources, such as an external power source (e.g., an electricity outlet), photovoltaic device, or power cell, may be used. Power source 1808 may further include power circuitry for delivering power from power source 1808 itself, and/or an external power source, to the various parts of UE 1800 via input circuitry or an interface such as an electrical power cable. Delivering power may be, for example, for charging of power source 1808. Power circuitry may perform any formatting, converting, or other modification to the power from power source 1808 to make the power suitable for the respective components of UE 1800 to which power is supplied.

Memory 1810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1810 includes one or more application programs 1814, such as an operating system, web browser application, a widget, gadget engine, or other application, and corresponding data 1816. Memory 1810 may store, for use by UE 1800, any of a variety of various operating systems or combinations of operating systems.

Memory 1810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1810 may allow UE 1800 to access instructions, application programs and the like, stored on transitory or non- transitory memory media, to off-load data, or to upload data. An article of manufacture, such as one utilizing a communication system may be tangibly embodied as or in memory 1810, which may be or comprise a device-readable storage medium.

Processing circuitry 1802 may be configured to communicate with an access network or other network using communication interface 1812. Communication interface 1812 may comprise one or more communication subsystems and may include or be communicatively coupled to an antenna 1822. Communication interface 1812 may include one or more transceivers used to communicate, such as by communicating with one or more remote transceivers of another device capable of wireless communication (e.g., another UE or a network node in an access network). Each transceiver may include a transmitter 1818 and/or a receiver 1820 appropriate to provide network communications (e.g., optical, electrical, frequency allocations, and so forth). Moreover, transmitter 1818 and receiver 1820 may be coupled to one or more antennas (e.g., antenna 1822) and may share circuit components, software or firmware, or alternatively be implemented separately.

In the illustrated embodiment, communication functions of communication interface 1812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1800 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node 1900 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1900 includes processing circuitry 1902, a memory 1904, a communication interface 1906, and a power source 1908. Network node 1900 may be composed of multiple physically separate components (e.g., a NodeB component and a RNC component, or a BTS component and a BSC component, etc.), which may each have their own respective components. In certain scenarios in which network node 1900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1900 may be configured to support multiple radio access technologies (RATs). In such embodiments, some components may be duplicated (e.g., separate memory 1904 for different RATs) and some components may be reused (e.g., a same antenna 1910 may be shared by different RATs). Network node 1900 may also include multiple sets of the various illustrated components for different wireless technologies integrated into network node 1900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1900.

Processing circuitry 1902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1900 components, such as memory 1904, to provide network node 1900 functionality.

In some embodiments, processing circuitry 1902 includes a system on a chip (SOC). In some embodiments, processing circuitry 1902 includes radio frequency (RF) transceiver circuitry 1912 and/or baseband processing circuitry 1914. In some embodiments, RF transceiver circuitry 1912 and baseband processing circuitry 1914 may be on separate chips (or sets of chips), boards, or units, such as radio units and digital units. In alternative embodiments, part or all of RF transceiver circuitry 1912 and baseband processing circuitry 1914 may be on the same chip or set of chips, boards, or units.

Memory 1904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1902. Memory 1904 may store any suitable instructions, data, or information, including a computer program, software, an application including one or more of logic, rules, code, tables, and/or other instructions (collectively denoted computer program 1904a, which may be a computer program product) capable of being executed by processing circuitry 1902 and utilized by network node 1900. Memory 1904 may be used to store any calculations made by processing circuitry 1902 and/or any data received via communication interface 1906. In some embodiments, processing circuitry 1902 and memory 1904 is integrated.

Communication interface 1906 is used in wired or wireless communication of signaling and/or data between a network node, access network, and/or UE. As illustrated, communication interface 1906 comprises port(s)/terminal(s) 1916 to send and receive data, for example to and from a network over a wired connection. Communication interface 1906 also includes radio front-end circuitry 1918 that may be coupled to, or in certain embodiments a part of, antenna 1910. Radio front-end circuitry 1918 comprises filters 1920 and amplifiers 1922. Radio front-end circuitry 1918 may be connected to an antenna 1910 and processing circuitry 1902. Radio front-end circuitry 1918 may be configured to condition signals communicated between antenna 1910 and processing circuitry 1902. Radio front-end circuitry 1918 may receive digital data that is to be sent out to other network nodes or UEs via a wireless connection. Radio front-end circuitry 1918 may convert the digital data into a radio signal having the appropriate channel and bandwidth parameters using a combination of filters 1920 and/or amplifiers 1922. The radio signal may then be transmitted via antenna 1910. Similarly, when receiving data, antenna 1910 may collect radio signals which are then converted into digital data by radio front-end circuitry 1918. The digital data may be passed to processing circuitry 1902. In other embodiments, the communication interface may comprise different components and/or different combinations of components.

In certain alternative embodiments, network node 1900 does not include separate radio front-end circuitry 1918, instead, processing circuitry 1902 includes radio front-end circuitry and is connected to antenna 1910. Similarly, in some embodiments, all or some of RF transceiver circuitry 1912 is part of communication interface 1906. In still other embodiments, communication interface 1906 includes one or more ports or terminals 1916, radio front-end circuitry 1918, and RF transceiver circuitry 1912, as part of a radio unit (not shown), and communication interface 1906 communicates with baseband processing circuitry 1914, which is part of a digital unit (not shown).

Antenna 1910 may include one or more antennas, or antenna arrays, configured to send and/or receive wireless signals. Antenna 1910 may be coupled to radio front-end circuitry 1918 and may be any type of antenna capable of transmitting and receiving data and/or signals wirelessly. In certain embodiments, antenna 1910 is separate from network node 1900 and connectable to network node 1900 through an interface or port.

Antenna 1910, communication interface 1906, and/or processing circuitry 1902 may be configured to perform any receiving operations and/or certain obtaining operations described herein as being performed by the network node. Any information, data and/or signals may be received from a UE, another network node and/or any other network equipment. Similarly, antenna 1910, communication interface 1906, and/or processing circuitry 1902 may be configured to perform any transmitting operations described herein as being performed by the network node. Any information, data and/or signals may be transmitted to a UE, another network node and/or any other network equipment.

Power source 1908 provides power to the various components of network node 1900 in a form suitable for the respective components (e.g., at a voltage and current level needed for each respective component). Power source 1908 may further comprise, or be coupled to, power management circuitry to supply the components of network node 1900 with power for performing the functionality described herein. For example, network node 1900 may be connectable to an external power source (e.g., the power grid, an electricity outlet) via an input circuitry or interface such as an electrical cable, whereby the external power source supplies power to power circuitry of power source 1908. As a further example, power source 1908 may comprise a source of power in the form of a battery or battery pack which is connected to, or integrated in, power circuitry. The battery may provide backup power should the external power source fail.

Embodiments of network node 1900 may include additional components beyond those shown in FIG. 19 for providing certain aspects of the network node's functionality, including any of the functionality described herein and/or any functionality necessary to support the subject matter described herein. For example, network node 1900 may include user interface equipment to allow input of information into network node 1900 and to allow output of information from network node 1900. This may allow a user to perform diagnostic, maintenance, repair, and other administrative functions for network node 1900.

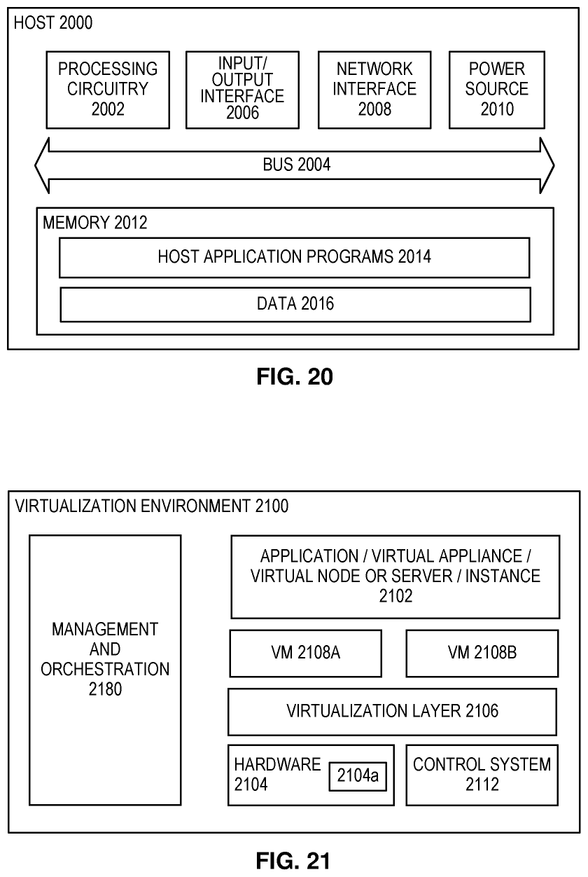

FIG. 20 is a block diagram of a host 2000, which may be an embodiment of host 1716 of FIG. 17, in accordance with various aspects described herein. As used herein, host 2000 may be or comprise various combinations hardware and/or software, including a standalone server, a blade server, a cloud-implemented server, a distributed server, a virtual machine, container, or processing resources in a server farm. Host 2000 may provide one or more services to one or more UEs.

Host 2000 includes processing circuitry 2002 that is operatively coupled via a bus 2004 to an input/output interface 2006, a network interface 2008, a power source 2010, and a memory 2012. Other components may be included in other embodiments. Features of these components may be substantially similar to those described with respect to the devices of previous figures, such as FIGS. 18 and 19, such that the descriptions thereof are generally applicable to the corresponding components of host 2000.

Memory 2012 may include one or more computer programs including one or more host application programs 2014 and data 2016, which may include user data, e.g., data generated by a UE for host 2000 or data generated by host 2000 for a UE. Embodiments of host 2000 may utilize only a subset or all of the components shown. Host application programs 2014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 2014 may also provide for user authentication and licensing checks and may periodically report health, routes, and content availability to a central node, such as a device in or on the edge of a core network. Accordingly, host 2000 may select and/or indicate a different host for over-the-top services for a UE. Host application programs 2014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2102 (which may alternatively be called software instances, virtual appliances, network functions, virtual nodes, virtual network functions, etc.) are run in the virtualization environment 2000 to implement some of the features, functions, and/or benefits of some of the embodiments disclosed herein.

Hardware 2104 includes processing circuitry, memory that stores software and/or instructions (collectively denoted computer program 2104a, which may be a computer program product) executable by hardware processing circuitry, and/or other hardware devices as described herein, such as a network interface, input/output interface, and so forth. Software may be executed by the processing circuitry to instantiate one or more virtualization layers 2106 (also referred to as hypervisors or virtual machine monitors (VMMs)), provide VMs 2108a-b (one or more of which may be generally referred to as VMs 2108), and/or perform any of the functions, features and/or benefits described in relation with some embodiments described herein. Virtualization layer 2106 may present a virtual operating platform that appears like networking hardware to VMs 2108.

VMs 2108 comprise virtual processing, virtual memory, virtual networking or interface and virtual storage, and may be run by a corresponding virtualization layer 2106. Different embodiments of the instance of a virtual appliance 2102 may be implemented on one or more of VMs 2108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 2108 may be a software implementation of a physical machine that runs programs as if they were executing on a physical, non-virtualized machine. Each VM 2108, and that part of hardware 2104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2108 on top of the hardware 2104 and corresponds to application 2102.

Hardware 2104 may be implemented in a standalone network node with generic or specific components. Hardware 2104 may implement some functions via virtualization. Alternatively, hardware 2104 may be part of a larger cluster of hardware (e.g. such as in a data center or CPE) where many hardware nodes work together and are managed via management and orchestration 2110, which, among others, oversees lifecycle management of applications 2102. In some embodiments, hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2112 which may alternatively be used for communication between hardware nodes and radio units.

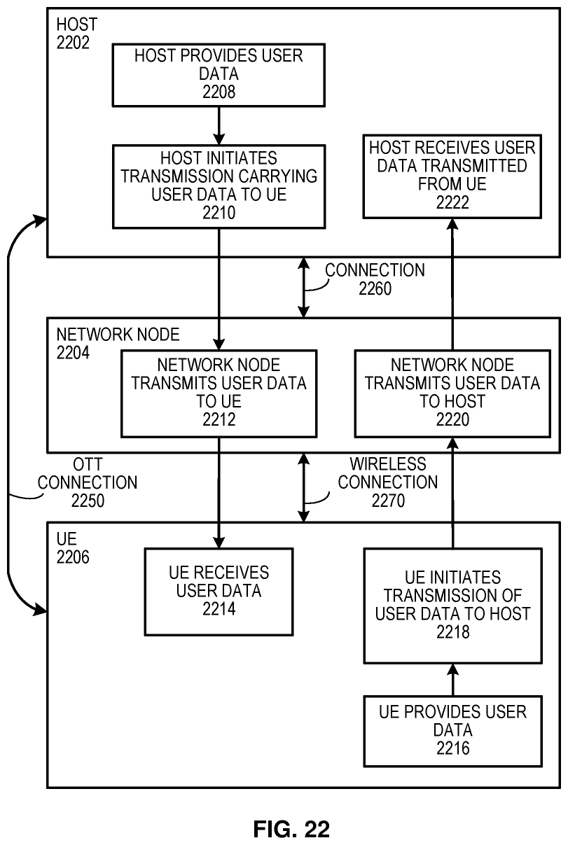

FIG. 22 shows a communication diagram of a host 2202 communicating via a network node 2204 with a UE 2206 over a partially wireless connection in accordance with some embodiments. Example implementations, in accordance with various embodiments, of the UE (such as a UE 1712a of FIG. 17 and/or UE 1800 of FIG. 18), network node (such as network node 1710a of FIG. 17 and/or network node 1900 of FIG. 19), and host (such as host 1716 of FIG. 17 and/or host 2000 of FIG. 20) discussed in the preceding paragraphs will now be described with reference to FIG. 22.

Like host 2000, embodiments of host 2202 include hardware, such as a communication interface, processing circuitry, and memory. Host 2202 also includes software, which is stored in or accessible by host 2202 and executable by the processing circuitry. The software includes a host application that may be operable to provide a service to a remote user, such as UE 2206 connecting via an over-the-top (OTT) connection 2250 extending between UE 2206 and host 2202. In providing the service to the remote user, a host application may provide user data which is transmitted using OTT connection 2250.

Network node 2204 includes hardware enabling it to communicate with host 2202 and UE 2206. Connection 2260 may be direct or pass through a core network (like core network 1706 of FIG. 17) and/or one or more other intermediate networks, such as one or more public, private, or hosted networks. For example, an intermediate network may be a backbone network or the Internet.

UE 2206 includes hardware and software, which is stored in or accessible by UE 2206 and executable by the UE's processing circuitry. The software includes a client application, such as a web browser or operator-specific “app” that may be operable to provide a service to a human or non-human user via UE 2206 with the support of host 2202. In host 2202, an executing host application may communicate with the executing client application via OTT connection 2250 terminating at UE 2206 and host 2202. In providing the service to the user, the UE's client application may receive request data from the host's host application and provide user data in response to the request data. OTT connection 2250 may transfer both the request data and the user data. The UE's client application may interact with the user to generate the user data that it provides to the host application through OTT connection 2250. OTT connection 2250 may extend via a connection 2260 between host 2202 and network node 2204 and via a wireless connection 2270 between network node 2204 and UE 2206 to provide the connection between host 2202 and UE 2206. Connection 2260 and wireless connection 2270, over which OTT connection 2250 may be provided, have been drawn abstractly to illustrate the communication between host 2202 and UE 2206 via network node 2204, without explicit reference to any intermediary devices and the precise routing of messages via these devices.

As an example of transmitting data via OTT connection 2250, in step 2208, host 2202 provides user data, which may be performed by executing a host application. In some embodiments, the user data is associated with a particular human user interacting with UE 2206. In other embodiments, the user data is associated with a UE 2206 that shares data with host 2202 without explicit human interaction. In step 2210, host 2202 initiates a transmission carrying the user data towards UE 2206. Host 2202 may initiate the transmission responsive to a request transmitted by UE 2206. The request may be caused by human interaction with UE 2206 or by operation of the client application executing on UE 2206. The transmission may pass via network node 2204, in accordance with the teachings of the embodiments described throughout this disclosure. Accordingly, in step 2212, network node 2204 transmits to UE 2206 the user data that was carried in the transmission that host 2202 initiated, in accordance with the teachings of the embodiments described throughout this disclosure. In step 2214, UE 2206 receives the user data carried in the transmission, which may be performed by a client application executed on UE 2206 associated with the host application executed by host 2202.

In some examples, UE 2206 executes a client application which provides user data to host 2202. The user data may be provided in reaction or response to the data received from host 2202. Accordingly, in step 2216, UE 2206 may provide user data, which may be performed by executing the client application. In providing the user data, the client application may further consider user input received from the user via an input/output interface of UE 2206. Regardless of the specific 35 manner in which the user data was provided, UE 2206 initiates, in step 2218, transmission of the user data towards host 2202 via network node 2204. In step 2220, in accordance with the teachings of the embodiments described throughout this disclosure, network node 2204 receives user data from UE 2206 and initiates transmission of the received user data towards host 2202. In step 2222, host 2202 receives the user data carried in the transmission initiated by UE 2206.

One or more of the various embodiments improve the performance of OTT services provided to UE 2206 using OTT connection 2250, in which wireless connection 2270 forms the last segment. More precisely, embodiments disclosed herein can provide a UE with knowledge about what stored conditional reconfigurations that it should maintain (e.g., to facilitate a subsequent mobility procedure with low delay or latency) after a cell group change or other mobility procedure. In this manner, both UE and network are aware of conditional reconfigurations that the UE is evaluating at any given moment, which can prevent configuration mismatches between UE and network. This can also prevent unnecessary reconfiguration failures due to the network assuming the UE is operating with a different configuration than it actually is. At a high level, embodiments can improve mobility robustness for both UEs and networks. Thus, embodiments increase the value of OTT services delivered via UEs and networks (improved in this manner) to both end users and service providers.

In an example scenario, factory status information may be collected and analyzed by host 2202. As another example, host 2202 may process audio and video data which may have been retrieved from a UE for use in creating maps. As another example, host 2202 may collect and analyze real-time data to assist in controlling vehicle congestion (e.g., controlling traffic lights). As another example, host 2202 may store surveillance video uploaded by a UE. As another example, host 2202 may store or control access to media content such as video, audio, VR or AR which it can broadcast, multicast or unicast to UEs. As other examples, host 2202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 2250 between host 2202 and UE 2206, in response to variations in the measurement results. The measurement procedure and/or the network functionality for reconfiguring the OTT connection may be implemented in software and hardware of host 2202 and/or UE 2206. In some embodiments, sensors (not shown) may be deployed in or in association with other devices through which OTT connection 2250 passes; the sensors may participate in the measurement procedure by supplying values of the monitored quantities exemplified above, or supplying values of other physical quantities from which software may compute or estimate the monitored quantities. The reconfiguring of OTT connection 2250 may include message format, retransmission settings, preferred routing etc.; the reconfiguring need not directly alter the operation of network node 2204. Such procedures and functionalities may be known and practiced in the art. In certain embodiments, measurements may involve proprietary UE signaling that facilitates measurements of throughput, propagation times, latency and the like, by host 2202. The measurements may be implemented in that software causes messages to be transmitted, in particular empty or ‘dummy’ messages, using OTT connection 2250 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:
A1. A method for a user equipment (UE) configured to communicate with a radio access network (RAN) via a master cell group (MCG) and a secondary cell group (SCG), the method comprising:
   receiving a plurality of conditional reconfigurations from the RAN, wherein each conditional reconfiguration is associated with a mobility procedure, one or more candidate target cells, and an execution condition;
   storing the plurality of conditional reconfigurations;
   executing a first mobility procedure towards a first target cell served by a second RAN node, according to a first reconfiguration; and
   selectively maintaining or releasing each of the stored conditional reconfigurations, after executing the mobility procedure.
A2. The method of embodiment A1, wherein selectively maintaining or releasing each of the stored conditional reconfigurations is based on one or more of the following:
   an indication received from the RAN in relation to the first mobility procedure;
   content of the conditional reconfiguration;
   content of one or more other of the conditional reconfigurations;
   type of the mobility procedure associated with the conditional reconfiguration;
   identity of the first target cell;
   content of the first reconfiguration;
   type of the executed first mobility procedure;
   number of mobility procedures executed by the UE while the conditional reconfiguration has been stored;
   duration that the conditional reconfiguration has been stored;
   state of the first target cell, or cell group comprising the first target cell, after execution of the first mobility procedure,
   state of a candidate target cell after execution of the corresponding mobility procedure; and
   a match or correspondence between one or more parameters of the first configuration and one or more parameters of the conditional reconfiguration.
A2a. The method of embodiment A2, wherein each conditional reconfiguration includes a list of one or more of the following:
   other candidate target cells whose associated conditional reconfigurations should be maintained by the UE after executing the conditional configuration, and
   candidate target nodes that provide candidate target cells whose associated conditional reconfigurations should be maintained by the UE after executing the conditional configuration.
A3. The method of any of embodiments A2-A2a, wherein each of conditional reconfigurations is associated with one of the following mobility procedures:
   conditional handover (CHO), wherein the candidate target cell is a primary cell (PCell) of an MCG;
   conditional primary SCG cell (PSCell) addition (CPA), wherein the candidate target cell is the PSCell; and
   conditional PSCell change (CPC), wherein the candidate target cell is the PSCell;
A3a. The method of embodiment A3, wherein:
   each conditional reconfiguration includes an indication of whether the candidate target cell is activated or deactivated after execution of the associated mobility procedure; and
   selectively maintaining or releasing each of the stored conditional reconfigurations is based on the indication included in that conditional reconfiguration.
A3b. The method of any of embodiments A3-A3a, wherein the first mobility procedure is one of the following: CHO, CPC, CPA, non-conditional handover, non-conditional PSCell change, non-conditional PSCell addition, cell group addition, cell group modification, and cell group release.
A3c. The method of any of embodiments A3-A3b, wherein the first configuration is one of the stored conditional reconfigurations, which is associated with the corresponding first mobility procedure towards the first target cell.
A3d. The method of any of embodiments A3-A3c, wherein selectively maintaining or releasing each of the stored conditional reconfigurations comprises maintaining the stored conditional reconfigurations when the first mobility procedure is a handover or a conditional handover, and releasing the stored conditional when the first mobility procedure is one of the following: a non-conditional PSCell change, a CPC, a non-conditional PSCell addition, or a CPA.
A4. The method of any of embodiments A2-A3b, wherein:
   the first mobility procedure is a non-conditional PSCell addition or a non-conditional PSCell change, in which the first target cell is a first PSCell of a first SCG;
   the first reconfiguration includes a first indication of whether the first PSCell and/or the first SCG is activated or deactivated after execution of the first mobility procedure; and
   selectively maintaining or releasing the stored conditional reconfigurations is based on the first indication.
A5. The method of any of embodiments A2-A4, wherein selectively maintaining or releasing each of the stored conditional reconfiguration comprises maintaining the conditional reconfigurations that have been stored during execution of less than a predetermined number of mobility procedures, and releasing the conditional reconfigurations that have been stored during execution of at least the predetermined number of mobility procedures.
A6. The method of any of embodiments A2-A4, wherein selectively maintaining or releasing each of the stored conditional reconfiguration comprises maintaining the conditional reconfigurations that have been stored less than a predetermined duration, and releasing the conditional reconfigurations that have been stored at least the predetermined duration.
A7. The method of any of embodiments A2-A4, wherein selectively maintaining or releasing each of the stored conditional reconfiguration comprises releasing the conditional reconfigurations that include a delta configuration, and maintaining the conditional reconfigurations that include a full configuration or an indication to release and then add an SCG configuration.
A8. The method of any of embodiments A2-A4, wherein for each of the stored conditional reconfigurations, selectively maintaining or releasing the stored conditional reconfiguration is based on one of the following:
   one or more indications received from a first RAN node before execution of the first mobility procedure; or
   one or more indications received from the second RAN node after execution of the first mobility procedure.
A8a. The method of embodiment A8, wherein one of the following applies:
   the one or more indications include a single indication that applies to all stored conditional reconfigurations; or
   the one or more indications include a plurality of indications corresponding to the respectively plurality of stored conditional reconfigurations.
A8b. The method of any of embodiments A8-A8a, wherein for each of the stored conditional reconfigurations, selectively maintaining or releasing the conditional reconfiguration after executing the mobility procedure comprises one or more of the following:
   maintaining the conditional reconfiguration unless receiving a corresponding indication to release from the second RAN node;
   releasing the conditional reconfiguration when no corresponding indication is received from the second RAN node within a predetermined duration after executing the first mobility procedure;
   refraining from evaluating execution conditions associated with the conditional reconfiguration until receiving a corresponding indication from the second RAN node;
   continuing to evaluate execution conditions associated with the conditional reconfiguration until receiving a corresponding indication from the second RAN node; and
   refraining from execution of the mobility procedure associated with the conditional reconfiguration when the execution condition has been met, until receiving a corresponding indication from the second RAN node.
A9. The method of any of embodiments A2-A8, wherein for each of the stored conditional reconfigurations, selectively maintaining or releasing the conditional reconfiguration after executing the mobility procedure is based on one or more of the following:
   whether the conditional reconfiguration includes a further conditional reconfiguration and if so, a type of the further conditional configuration;
   whether both the conditional reconfiguration and the first reconfiguration include an indication that the conditional reconfiguration is maintained after execution of the mobility procedure.
A10. The method of any of embodiments Al-A9, further comprising sending to the RAN one or more of the following information:
   an indication of UE support or capability for maintaining stored conditional reconfigurations after execution of a mobility procedure; and
   for each of the stored conditional reconfigurations, one or more of the following:
      identifier of the conditional reconfiguration;
      identifiers of the associated one or more candidate target cells;
      the execution conditions associated with the conditional reconfiguration;
      a measurement configuration associated with the conditional reconfiguration;
      type of the mobility procedure associated with the conditional reconfiguration;
      whether the conditional reconfiguration is a full configuration or a delta configuration;
      whether the conditional reconfiguration includes an indication to release and then add an SCG or includes a delta configuration for the SCG; and
      UE measurement results for the associated one or more candidate target cells.
A11. The method of embodiment A10, wherein the information is sent according to one of the following:
   to a first RAN node that provides the MCG, before executing the first mobility procedure; or
   to the second RAN node after executing the first mobility procedure.
B1. A method for a first RAN node configured to provide a master cell group (MCG) for a user equipment (UE) that is also configured to communicate with the RAN via a secondary cell group (SCG), the method comprising:
   performing one or more of the following operations:
      sending, to each of one or more other RAN nodes, information about conditional reconfigurations stored by the UE, wherein each conditional reconfiguration is associated with a mobility procedure, one or more candidate target cells, and an execution condition; and
      receiving, from each of one or more other RAN nodes, information about candidate target cells associated with conditional reconfigurations that should be maintained by the UE after executing a mobility procedure to a target cell provided by the other RAN node;
   subsequently performing and/or facilitating a first mobility procedure for the UE towards a first target cell, according to a first reconfiguration.
B2. The method of embodiment B1, wherein each of the conditional reconfigurations is associated with one of the following mobility procedures:
   conditional handover (CHO), wherein the candidate target cell is a primary cell (PCell) of an MCG;
   conditional primary SCG cell (PSCell) addition (CPA), wherein the candidate target cell is the PSCell; and
   conditional PSCell change (CPC), wherein the candidate target cell is the PSCell.
B2a. The method of any of embodiments B1-B2, wherein the first mobility procedure is one of the following: CHO, CPC, CPA, non-conditional handover, non-conditional PSCell change, non-conditional PSCell addition, cell group addition, cell group modification, and cell group release.
B2b. The method of any of embodiments B1-B2a, wherein the first configuration is one of the stored conditional reconfigurations, which is associated with the corresponding first mobility procedure towards the first target cell.
B2c. The method of any of embodiments B1-B2b, wherein the information sent to and/or received from each of the one or more RAN nodes includes identifiers of one or more of the following:
   conditional reconfigurations that should be maintained;
   candidate target cells associated with conditional reconfigurations that should be maintained; and
   candidate target nodes that provide candidate target cells associated with conditional reconfigurations that should be maintained.
B3. The method of any of embodiments B1-B2c, further comprising sending to the UE a plurality of conditional reconfigurations, wherein each conditional reconfiguration is associated with a mobility procedure, one or more candidate target cells, and an execution condition.
B4. The method of embodiment B3, further comprising sending to the UE one or more indications of whether the UE should maintain or release the plurality of conditional reconfigurations upon execution of a mobility procedure.
B4a. The method of embodiment B4, wherein one of the following applies:
   the one or more indications include a single indication that applies to all the conditional reconfigurations; or
   the one or more indications include a plurality of indications corresponding to the respectively plurality of conditional reconfigurations.
B4b. The method of any of embodiments B4-B4a, wherein each conditional reconfiguration sent to the UE includes identifiers of one or more of the following:
   other conditional reconfigurations that should be maintained;
   other candidate target cells associated with other conditional reconfigurations that should be maintained; and
   candidate target nodes that provide other candidate target cells associated with other conditional reconfigurations that should be maintained.
B5. The method of any of embodiments B1-B4b, wherein:
   each conditional reconfiguration is also associated with a candidate target node that provides the associated one or more candidate target cells; and
   the one or more RAN nodes, to which the information is sent, include the plurality of candidate target nodes.
B6. The method of embodiment B5, wherein the information sent to each candidate target node identifies stored conditional configurations, associated with other candidate target cells provided by other candidate target node, that should be maintained by the UE after executing one of the following:
   a mobility procedure to a candidate target cell provided by the candidate target node, or any mobility procedure.
B7. The method of any of embodiments B1-B4b, wherein the information is sent to a second RAN node configured to provide the first target cell.
B8. The method of any of embodiments B1-B4b, wherein the information is received from a source RAN node configured to provide a source cell for the first mobility procedure.
B9. The method of any of embodiments B1-B4b, wherein:
   the information is received from a plurality of candidate target nodes, with each candidate target node providing one or more candidate target cells for a mobility procedure associated with a conditional reconfiguration; and
   the information received from each candidate target node identifies other conditional reconfigurations that should be maintained after the UE executes the mobility procedure associated with the conditional reconfiguration.
B10. The method of embodiment B9, further comprising receiving the plurality of conditional reconfigurations from the plurality of candidate target nodes, wherein the information that identifies other conditional reconfigurations that should be maintained is included in or with the respective conditional reconfigurations.
B11. The method of any of embodiments B1-B10, further comprising receiving one or more of the following information from the UE before performing and/or facilitating the first mobility procedure:
   an indication of UE support or capability for maintaining stored conditional reconfigurations after execution of a mobility procedure; and
   for each conditional reconfiguration stored by the UE, one or more of the following:
      identifier of the conditional reconfiguration;
      identifiers of the associated one or more candidate target cells;
      the execution conditions associated with the conditional reconfiguration;
      a measurement configuration associated with the conditional reconfiguration;
      type of the mobility procedure associated with the conditional reconfiguration;
      whether the conditional reconfiguration is a full configuration or a delta configuration;
      whether the conditional reconfiguration includes an indication to release and then add an SCG or includes a delta configuration for the SCG and
      UE measurement results for the associated one or more candidate target cells.
B12. The method of embodiment B11, wherein the information sent to the one or more other RAN nodes is based on the information received from the UE.
C1. A method for a second radio access network (RAN) node configured as a target node or a candidate target node for a mobility procedure by a user equipment (UE), the method comprising one or more of the following:
   receiving, from a first RAN node configured to provide a master cell group (MCG) for the UE, information about a plurality of conditional reconfigurations stored by the UE, wherein each conditional reconfiguration is associated with a mobility procedure, one or more candidate target cells, and an execution condition; and
   sending, to the first RAN node, information about candidate target cells associated with conditional reconfigurations that should be maintained by the UE after executing a mobility procedure to a target cell provided by the second RAN node.
C2. The method of embodiment C1, wherein each of the conditional reconfigurations is associated with one of the following mobility procedures:
   conditional handover (CHO), wherein the candidate target cell is a primary cell (PCell) of an MCG;
   conditional primary SCG cell (PSCell) addition (CPA), wherein the candidate target cell is the PSCell; and
   conditional PSCell change (CPC), wherein the candidate target cell is the PSCell;
C3. The method of any of embodiments C1-C2, wherein the first mobility procedure is one of the following: CHO, CPC, CPA, non-conditional handover, non-conditional PSCell change, non-conditional PSCell addition, cell group addition, cell group modification, and cell group release.
C4. The method of any of embodiments C1-C3, wherein the information sent to and/or received from the first RAN node includes identifiers of one or more of the following:
   conditional reconfigurations that should be maintained;
   candidate target cells associated with conditional reconfigurations that should be maintained; and
   candidate target nodes that provide candidate target cells associated with conditional reconfigurations that should be maintained.
C5. The method of any of embodiments C1-C4, wherein the information received from the first RAN node include one or more of the following:
   an indication of UE support or capability for maintaining stored conditional reconfigurations after execution of a mobility procedure; and
   for each conditional reconfiguration stored by the UE, one or more of the following:
      identifier of the conditional reconfiguration;
      identifiers of the associated one or more candidate target cells;
      the execution conditions associated with the conditional reconfiguration;
      a measurement configuration associated with the conditional reconfiguration;
      type of the mobility procedure associated with the conditional reconfiguration;
      whether the conditional reconfiguration is a full configuration or a delta configuration;
      whether the conditional reconfiguration includes an indication to release and then add an SCG or includes a delta configuration for the SCG and
      UE measurement results for the associated one or more candidate target cells.
C6. The method of any of embodiments C1-C5, further comprising:
   performing and/or facilitating a first mobility procedure for the UE towards a first target cell served by the second RAN node, according to a first reconfiguration; and
   based on the information received from the first RAN node, determining whether each of the conditional reconfigurations stored by the UE should be maintained after the first mobility procedure.
C7. The method of embodiment C6, wherein one of the following applies:
   the method further comprises sending to the UE, after the first mobility procedure, one or more indications of whether the UE should maintain or release the plurality of conditional reconfigurations; or
   the information about candidate target cells associated with conditional reconfigurations that should be maintained is sent to the first RAN node before the first mobility procedure.
C8. The method of embodiment C7, wherein the one or more indications are sent to the RAN node in or together with the first reconfiguration.
C9. The method of any of embodiments C6-C8, wherein one of the following applies:
   the one or more indications include a single indication that applies to all the conditional reconfigurations; or
   the one or more indications include a plurality of indications corresponding to the respectively plurality of conditional reconfigurations.
C10. The method of any of embodiments C1-C5, wherein:
   the second RAN node is candidate target node that provides a candidate target cell associated with one of the conditional reconfigurations; and
   the method further comprises sending the conditional reconfiguration associated with the candidate target cell to the first RAN node.
C10a. The method of embodiment C10, further comprising, based on the information received from the first RAN node, determining whether each of the conditional reconfigurations stored by the UE should be maintained after the mobility procedure associated with the conditional reconfiguration.
C11. The method of any of embodiments C10-C10a, wherein the information about candidate target cells associated with conditional reconfigurations that should be maintained is included in or with the conditional reconfiguration.
D1. A user equipment (UE) user equipment (UE) configured to communicate with a radio access network (RAN) via a master cell group (MCG) and a secondary cell group (SCG), the UE comprising:
   communication interface circuitry configured to communicate with the RAN via the SCG and the MCG; and
   processing circuitry operatively coupled to the communication interface circuitry, whereby the processing circuitry and the communication interface circuitry are configured to perform operations corresponding to any of the methods of embodiments A1-A11.
D2. A user equipment (UE) configured to communicate with a radio access network (RAN) via a master cell group (MCG) and a secondary cell group (SCG), the UE being further configured to perform operations corresponding to any of the methods of embodiments Al-A11.
D3. A non-transitory, computer-readable medium storing computer-executable instructions that, when executed by processing circuitry of a user equipment (UE) configured to communicate with a radio access network (RAN) via a master cell group (MCG) and a secondary cell group (SCG), configure the UE to perform operations corresponding to any of the methods of embodiments A1-A11.
D4. A computer program product comprising computer-executable instructions that, when executed by processing circuitry of a user equipment (UE) configured to communicate with a radio access network (RAN) via a master cell group (MCG) and a secondary cell group (SCG), configure the UE to perform operations corresponding to any of the methods of embodiments A1-A11.
E1. A first radio access network (RAN) configured to provide a master cell group (MCG) for a user equipment (UE) that is also configured to communicate with the RAN via a secondary cell group (SCG), the first RAN node comprising:
   communication interface circuitry configured to communicate with the UE via the MCG; and
   processing circuitry operatively coupled to the communication interface circuitry, whereby the processing circuitry and the communication interface circuitry are configured to perform operations corresponding to any of the methods of embodiments B1-B12.
E2. A first radio access network (RAN) configured to provide a master cell group (MCG) for a user equipment (UE) that is also configured to communicate with the RAN via a secondary cell group (SCG), the first RAN node being further configured to perform operations corresponding to any of the methods of embodiments B1-B12.
E3. A non-transitory, computer-readable medium storing computer-executable instructions that, when executed by processing circuitry of a first radio access network (RAN) configured to provide a master cell group (MCG) for a user equipment (UE) that is also configured to communicate with the RAN via a secondary cell group (SCG), configure the first RAN node to perform operations corresponding to any of the methods of embodiments B1-B12.
E4. A computer program product comprising computer-executable instructions that, when executed by processing circuitry of a first radio access network (RAN) configured to provide a master cell group (MCG) for a user equipment (UE) that is also configured to communicate with the RAN via a secondary cell group (SCG), configure the first RAN node to perform operations corresponding to any of the methods of embodiments B1-B12.
F1. A second radio access network (RAN) node configured as a target node or a candidate target node for a mobility procedure by a user equipment (UE), the second RAN node comprising:
   communication interface circuitry configured to communicate with the UE and with a first RAN node configured to provide a master cell group (MCG) for the UE; and
   processing circuitry operatively coupled to the communication interface circuitry, whereby the processing circuitry and the communication interface circuitry are configured to perform operations corresponding to any of the methods of embodiments C1-C11.
F2. A second radio access network (RAN) node configured as a target node or a candidate target node for a mobility procedure by a user equipment (UE), the second RAN node being further configured to perform operations corresponding to any of the methods of embodiments C1-C11.
F3. A non-transitory, computer-readable medium storing computer-executable instructions that, when executed by processing circuitry of a second radio access network (RAN) node configured as a target node or a candidate target node for a mobility procedure by a user equipment (UE), configure the second RAN node to perform operations corresponding to any of the methods of embodiments C1-C11.
F4. A computer program product comprising computer-executable instructions that, when executed by processing circuitry of a second radio access network (RAN) node configured as a target node or a candidate target node for a mobility procedure by a user equipment (UE), configure the second RAN node to perform operations corresponding to any of the methods of embodiments C1-C11.

1.-52. (canceled)

53. A method for user equipment (UE) configured to communicate with a radio access network (RAN) via at least a master cell group (MCG), the method comprising:
receiving a plurality of conditional reconfigurations from the RAN, wherein each conditional reconfiguration is associated with a mobility procedure, one or more candidate target cells, and an execution condition;
storing the plurality of conditional reconfigurations;
executing, according to a first reconfiguration, a first mobility procedure towards a first target cell served by a second RAN node, wherein the first mobility procedure and the plurality of stored conditional reconfigurations are associated with a same one of the following: the MCG, or a secondary cell group (SCG) for the UE; and
selectively maintaining or releasing each of the stored conditional reconfigurations, after executing the first mobility procedure.

54. The method of claim 53, wherein:
the first mobility procedure towards the first target cell is a handover or a conditional handover (CHO); and
each conditional reconfiguration is associated with a CHO mobility procedure and a candidate target cell that is a primary cell (PCell) of an MCG.

55. The method of claim 53, wherein:
the first mobility procedure towards the first target cell is one of the following: non-conditional primary SCG cell (PSCell) change, non-conditional PSCell addition, SCG addition, SCG modification, or SCG release; and
each conditional reconfiguration is associated with a candidate target cell that is a PSCell of an SCG and one of the following mobility procedures: conditional PSCell addition (CPA), or conditional PSCell change (CPC).

56. The method of claim 53, wherein:
the first mobility procedure towards the first target cell is one of the following: a conditional primary SCG cell (PSCell) addition (CPA), or a conditional PSCell change (CPC); and
each conditional reconfiguration is associated with a candidate target cell that is a PSCell of an SCG and one of the following mobility procedures: CPA, or CPC.

57. The method of claim 53, wherein selectively maintaining or releasing each of the stored conditional reconfigurations is based on the content of the stored conditional reconfiguration.

58. The method of claim 57, wherein:
the content of each stored conditional reconfiguration includes at least one field associated with a version or release of functionality; and
selectively maintaining or releasing each of the stored conditional reconfigurations is based on the version or release associated with the field.

59. The method of claim 57, wherein each conditional reconfiguration includes identifiers of one or more of the following:
other conditional reconfigurations that should be maintained by the UE after execution of the associated mobility procedure; and
other candidate target cells whose associated conditional reconfigurations should be maintained by the UE after execution of the associated mobility procedure.

60. A method for a first RAN node configured to provide a master cell group (MCG) for a user equipment (UE), the method comprising:
sending the following to the UE:
a plurality of conditional reconfigurations, wherein each conditional reconfiguration is associated with a mobility procedure, one or more candidate target cells, and an execution condition; and
one or more indications of whether the UE should maintain or release the plurality of conditional reconfigurations after execution of a first mobility procedure towards a first target cell served by a second RAN node, wherein the first mobility procedure and the plurality of conditional reconfigurations are associated with a same one of the following: the MCG, or a secondary cell group (SCG) for the UE; and
subsequently performing and/or facilitating, according to a first reconfiguration, the first mobility procedure for the UE towards the first target cell served by the second RAN node.

61. The method of claim 60, wherein the first configuration is one of the conditional reconfigurations for the UE, with the first configuration being associated with the first mobility procedure and the first target cell.

62. The method of claim 60, further comprising
sending to the second RAN node information about the plurality of conditional reconfigurations for the UE; and
receiving the following from the second RAN node: the first reconfiguration, and the one or more indications.

63. The method of claim 60, wherein:
each conditional reconfiguration includes at least one field associated with a version or release of functionality; and
the version or release further indicates whether the UE should maintain or release the conditional reconfiguration after execution of a mobility procedure.

64. A method for a second radio access network (RAN) node configured as a target node or a candidate target node for a mobility procedure by a user equipment (UE), the method comprising:
sending, to the UE or to a first RAN node configured to provide a master cell group (MCG) for the UE, one or more indications of whether the UE should maintain or release a plurality of conditional reconfigurations after execution of a first mobility procedure towards a first target cell served by the second RAN node, wherein:
each conditional reconfiguration is associated with a mobility procedure, one or more candidate target cells, and an execution condition; and
the first mobility procedure and the plurality of conditional reconfigurations are associated with a same one of the following: the MCG, or a secondary cell group (SCG) for the UE; and
performing and/or facilitating, according to a first reconfiguration, the first mobility procedure for the UE towards the first target cell served by the second RAN node.

65. The method of claim 64, further comprising:
receiving from the first RAN node information about the plurality of conditional reconfigurations; and
based on the received information, determining whether each of the conditional reconfigurations should be maintained or released by the UE after the first mobility procedure,
wherein the one or more indications are based on the determination.

66. User equipment (UE) configured to communicate with a radio access network (RAN) via at least a master cell group (MCG), the UE comprising:
communication interface circuitry configured to communicate with the RAN via at least the MCG; and
processing circuitry operatively coupled to the communication interface circuitry, wherein the processing circuitry and the communication interface circuitry are configured to:
receive a plurality of conditional reconfigurations from the RAN, wherein each conditional reconfiguration is associated with a mobility procedure, one or more candidate target cells, and an execution condition;
store the plurality of conditional reconfigurations;
execute, according to a first reconfiguration, a first mobility procedure towards a first target cell served by a second RAN node, wherein the first mobility procedure and the plurality of stored conditional reconfigurations are associated with a same one of the following: the MCG, or a secondary cell group (SCG) for the UE; and
selectively maintain or release each of the stored conditional reconfigurations, after executing the first mobility procedure.

67. The UE of claim 66, wherein:
the first mobility procedure towards the first target cell is a handover or a conditional handover (CHO); and
each conditional reconfiguration is associated with a CHO mobility procedure and a candidate target cell that is a primary cell (PCell) of an MCG.

68. The UE of claim 66, wherein:
the first mobility procedure towards the first target cell is one of the following: non-conditional primary SCG cell (PSCell) change, non-conditional PSCell addition, SCG addition, SCG modification, or SCG release; and
each conditional reconfiguration is associated with a candidate target cell that is a PSCell of an SCG and one of the following mobility procedures: conditional PSCell addition (CPA), or conditional PSCell change (CPC).

69. A first radio access network (RAN) node configured to provide a master cell group (MCG) for a user equipment (UE), the first RAN node comprising:
communication interface circuitry configured to communicate with the UE via the MCG; and
processing circuitry operatively coupled to the communication interface circuitry, wherein the processing circuitry and the communication interface circuitry are configured to perform the method of claim 60.

70. The first RAN node of claim 69, wherein the processing circuitry and the communication interface circuitry are further configured to:
send to the second RAN node information about the plurality of conditional reconfigurations for the UE; and
receive the following from the second RAN node: the first reconfiguration, and the one or more indications.

71. A second radio access network (RAN) node configured as a target node or a candidate target node for a mobility procedure by a user equipment (UE), the second RAN node comprising:
communication interface circuitry configured to communicate with the UE and with a first RAN node configured to provide a master cell group (MCG) for the UE; and
processing circuitry operatively coupled to the communication interface circuitry, wherein the processing circuitry and the communication interface circuitry are configured to perform the method of claim 64.

72. The second RAN node of claim 71, wherein the processing circuitry and the communication interface circuitry are further configured to:
receive from the first RAN node information about the plurality of conditional reconfigurations; and
based on the received information, determine whether each of the conditional reconfigurations should be maintained or released by the UE after the first mobility procedure,
wherein the one or more indications are based on the determination.
